(19) United States
(12) Patent Application Publication
(10) Pub. No.: US 2025/0074044 A1
(43) Pub. Date: Mar. 6, 2025

(54) HEAD UNIT AND LIQUID EJECTION APPARATUS

(71) Applicant: SEIKO EPSON CORPORATION, Tokyo (JP)

(72) Inventor: Shinichi YAMADA, Shiojiri (JP)

(21) Appl. No.: 18/820,364

(22) Filed: Aug. 30, 2024

(30) Foreign Application Priority Data
Sep. 1, 2023 (JP) 2023-142085

(51) Int. Cl. B41J 2/045; B41J 2/14

(52) U.S. Cl. CPC B41J 2/04563; B41J 2/04548; B41J 2/04581; B41J 2/04588; B41J 2/14233; B41J 2002/14491

(57) ABSTRACT

A head unit includes: an ejection unit that includes a piezoelectric element driven by a drive signal and that ejects a liquid; a waveform shaping circuit to which a first residual vibration signal corresponding to a residual vibration caused by the drive signal is input, and which outputs a second residual vibration signal; a temperature detection circuit that outputs a temperature information signal; and a determination circuit, wherein the waveform shaping circuit includes an amplifier circuit that amplifies the first residual vibration signal and a gain setting circuit, and outputs the second residual vibration signal based on a signal amplified by the amplifier circuit, the amplifier circuit and the gain setting circuit are configured as a single semiconductor device, and the determination circuit determines a state of the ejection unit based on the second residual vibration signal and the temperature information signal.

The present application is based on, and claims priority from JP Application Serial Number 2023-142085, filed Sep. 1, 2023, the disclosure of which is hereby incorporated by reference herein in its entirety.

### BACKGROUND

### 1. Technical Field

The present disclosure relates to a head unit and a liquid ejection apparatus.

### 2. Related Art

As described in JP-A-2005-211873, in the liquid ejection apparatus in which a piezoelectric element is driven to thereby eject ink from an ejection unit, there is known a technique that detects a signal corresponding to residual vibration generated after the piezoelectric element is driven, to determine the state of the ejection unit based on a detection result of that signal.

JP-A-2005-211873 is an example of the related art.

When the signal corresponding to the residual vibration is detected using the technique described in JP-A-2005-211873, and then the state of the ejection unit is determined based on the detection result, it is not sufficient from a viewpoint of further improvement of the determination accuracy of the state of the ejection unit, and there is room for further improvement.

### SUMMARY

An aspect of a head unit according to the present disclosure includes:
an ejection unit that includes a piezoelectric element driven by a drive signal and that is configured to eject a liquid in accordance with drive of the piezoelectric element;
a waveform shaping circuit to which a first residual vibration signal corresponding to a residual vibration caused by the drive signal is input, and which is configured to output a second residual vibration signal obtained by shaping a waveform of the first residual vibration signal;
a temperature detection circuit configured to output a temperature information signal corresponding to a temperature of the waveform shaping circuit; and
a determination circuit configured to determine a state of the ejection unit, wherein
the waveform shaping circuit includes an amplifier circuit configured to amplify the first residual vibration signal and a gain setting circuit configured to set a gain of the amplifier circuit, and is configured to output the second residual vibration signal based on a signal amplified by the amplifier circuit,
the amplifier circuit and the gain setting circuit are configured as a single semiconductor device, and
the determination circuit is configured to determine the state of the ejection unit based on the second residual vibration signal and the temperature information signal.

An aspect of a liquid ejection apparatus according to the present disclosure includes:
a head unit configured to eject a liquid onto a medium; and
a control unit configured to control an operation of the head unit, wherein
the head unit includes
an ejection unit that includes a piezoelectric element driven by a drive signal and that is configured to eject a liquid in accordance with drive of the piezoelectric element,
a waveform shaping circuit to which a first residual vibration signal corresponding to a residual vibration caused by the drive signal is input, and which is configured to output a second residual vibration signal obtained by shaping a waveform of the first residual vibration signal,
a temperature detection circuit configured to output a temperature information signal corresponding toa temperature of the waveform shaping circuit, and
a determination circuit configured to determine a state of the ejection unit,
the waveform shaping circuit includes an amplifier circuit configured to amplify the first residual vibration signal and a gain setting circuit configured to set a gain of the amplifier circuit, and is configured to output the second residual vibration signal based on a signal amplified by the amplifier circuit,
the amplifier circuit and the gain setting circuit are configured as a single semiconductor device, and
the determination circuit is configured to determine the state of the ejection unit based on the second residual vibration signal and the temperature information signal.

### BRIEF DESCRIPTION OF THE DRAWINGS

FIG. 1 is a diagram showing an example of a schematic configuration of a liquid ejection apparatus.

FIG. 2 is a diagram showing an example of a functional configuration of the liquid ejection apparatus.

FIG. 3 is a diagram illustrating a schematic configuration of an ejection unit.

FIG. 4 is a diagram illustrating an example of a signal waveform of a drive signal COM.

FIG. 5 is a diagram illustrating an example of a functional configuration of a drive signal selection circuit.

FIG. 6 is a diagram illustrating an example of a functional configuration of a switching circuit.

FIG. 7 is a diagram illustrating an example of decoding contents in a decoder.

FIG. 8 is a diagram illustrating a configuration of a selection circuit.

FIG. 9 is a diagram showing an example of an operation of the switching circuit.

FIG. 10 is a diagram illustrating an example of a configuration of a first waveform shaping circuit.

FIG. 11 shows an example of a configuration of a temperature detection circuit.

FIG. 12 is a diagram illustrating an example of a configuration of an ejection state determination circuit.

FIG. 13 is a diagram showing an example of a signal waveform of a residual vibration signal Vout.

FIG. 14 is a diagram illustrating a calculation model of a simple harmonic motion assuming a residual vibration that occurs in the ejection unit.

FIG. 15 is a diagram illustrating a relationship between the viscosity of ink and the signal waveform of the residual vibration.

FIG. 16 is a diagram illustrating a relationship between mixing of air bubbles and the signal waveform of the residual vibration.

FIG. 17 is a diagram illustrating an example of a method of acquiring waveform information of a residual vibration signal Vnvt and a method of determining a state of an ejection unit as an inspection target.

FIG. 18 is a diagram showing a specific example of reference potential acquisition processing.

FIG. 19 is a diagram illustrating a specific example of residual vibration signal acquisition processing.

FIG. 20 is a diagram illustrating a specific example of waveform information calculation processing.

FIG. 21 is a diagram illustrating a specific example of ejection unit determination processing.

FIG. 22 is a diagram illustrating an example of a configuration of an ejection state determination circuit in a modified example.

### DESCRIPTION OF EMBODIMENTS

A preferred embodiment of the present disclosure will hereinafter be described using the drawings. The drawings to be used are for the sake of convenience of explanation. Note that the embodiment to be described below does not unreasonably limit the content of the present disclosure set forth in the appended claims. Further, it is not necessarily true that all the configurations to be described below are essential elements of the present disclosure.

### 1. Overview of Liquid Ejection Apparatus

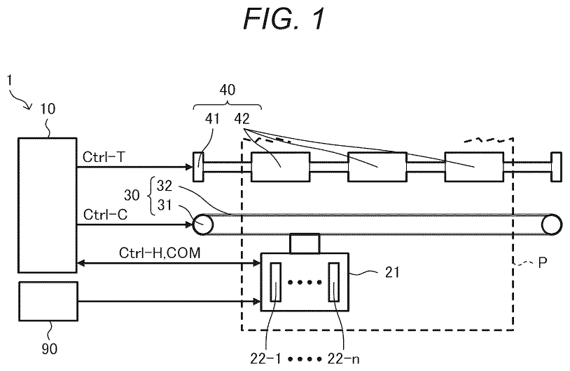

FIG. 1 is a diagram showing an example of a schematic configuration of a liquid ejection apparatus 1. The liquid ejection apparatus 1 according to the present embodiment is a so-called serial printing-type inkjet printer in which a carriage 21 mounted with print heads 22-1 to 22-n reciprocates along a scanning axis and the print heads 22-1 to 22-n eject ink as an example of the liquid to a medium P conveyed along a conveyance direction to thereby form a desired image on the medium P. As the medium P used in such a liquid ejection apparatus 1, any print medium such as a resin film or a fabric may be used in addition to printing paper such as plain paper. Note that the liquid ejection apparatus 1 is not limited to the serial printing-type inkjet printer, but may be a line printing-type inkjet printer. Further, the liquid ejection apparatus 1 is not limited to the inkjet printers, and may be a color material ejection apparatus used for manufacture of a color filter for a liquid crystal display or the like, an electrode material ejection apparatus used for formation of electrodes for an organic EL display, an FED (field emission display), or the like, or a bioorganic material ejection apparatus used for manufacture of a biochip, and may further be a three-dimensional modeling apparatus, a textile printing apparatus, or the like.

As shown in FIG. 1, the liquid ejection apparatus 1 includes a control unit 10, the print heads 22-1 to 22-n, a movement unit 30, a conveyance unit 40, and an ink container 90.

The ink container 90 stores a plurality of types of ink to be ejected onto the medium P. As such an ink container 90, an ink cartridge, an ink pack that is shaped like a bag, and is formed of a flexible film, an ink tank in which the ink can be replenished, or the like may be used.

The control unit 10 includes a processing circuit such as a CPU (central processing unit) or an FPGA (field programmable gate array) and a memory circuit such as a semiconductor memory, and controls elements of the liquid ejection apparatus 1.

The print heads 22-1 to 22-n are mounted on the carriage 21. Control signals Ctrl-H output by the control unit 10 and a drive signal COM are input to the print heads 22-1 to 22-n. The ink stored in the ink container 90 is supplied to the print heads 22-1 to 22-n through tubes or the like (not shown). Each of the print heads 22-1 to 22-n ejects the ink thus supplied to the medium P based on the control signals Ctrl-H and the drive signal COM.

The movement unit 30 includes a carriage motor 31 and an endless belt 32. The carriage motor 31 operates based on a control signal Ctrl-C input from the control unit 10. The carriage 21 loaded with the print heads 22-1 to 22-n is fixed to the endless belt 32. The endless belt 32 circulates in accordance with the operation of the carriage motor 31. Then, due to the circulation of the endless belt 32, the carriage 21 fixed to the endless belt 32 moves along the scanning direction. That is, the movement unit 30 controls the movement of the print heads 22-1 to 22-n mounted on the carriage 21.

The conveyance unit 40 includes a conveyance motor 41 and conveyance rollers 42. The conveyance motor 41 operates based on a control signal Ctrl-T input from the control unit 10. The conveyance rollers 42 rotate according to the operation of the conveyance motor 41 in a state of nipping the medium P. Due to the rotation of the conveyance rollers 42, the medium P nipped by the conveyance rollers 42 is conveyed along the conveyance direction. That is, the conveyance unit 40 controls the conveyance of the medium P.

In the liquid ejection apparatus 1 configured as described above, the movement unit 30 controls the reciprocation of the carriage 21 along the scanning direction, and the conveyance unit 40 controls the conveyance of the medium P along the conveyance direction. Then, each of the print heads 22-1 to 22-n mounted on the carriage 21 ejects the ink in tandem with the reciprocation of the carriage 21 and the conveyance of the medium P. Thus, the ink ejected from each of the print heads 22-1 to 22-n lands on an appropriate surface of the medium P, and thus, a desired image is formed on the medium P.

### 2. Functional Configuration of Liquid Ejection Apparatus

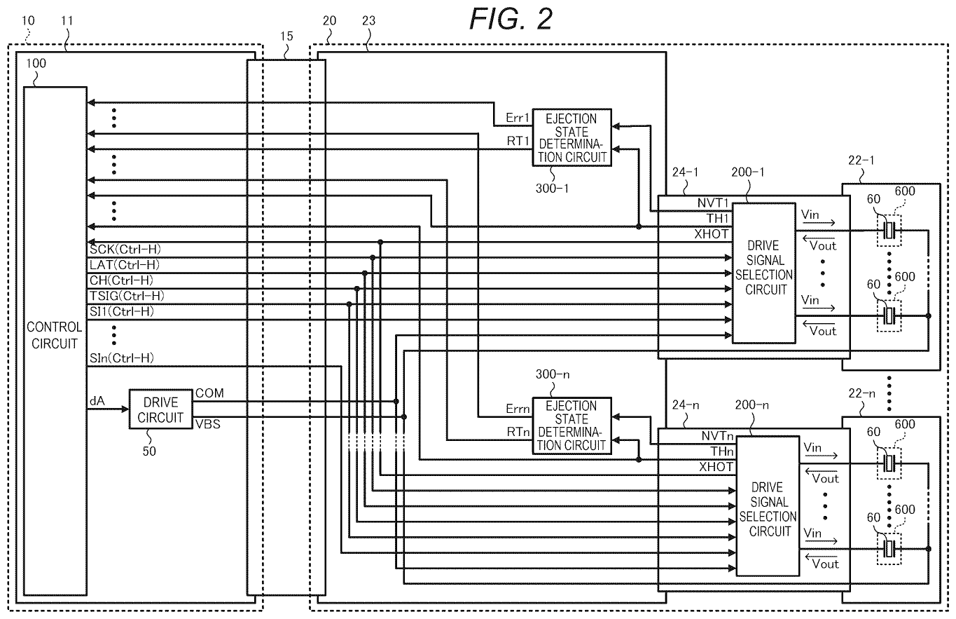

Then, a functional configuration of the liquid ejection apparatus 1 will be described. FIG. 2 is a diagram showing an example of the functional configuration of the liquid ejection apparatus 1. As illustrated in FIG. 2, the liquid ejecting apparatus 1 includes the control unit 10 and the head unit 20.

The control unit 10 includes a control circuit board 11, a drive circuit 50, and a control circuit 100. The control circuit board 11 is a printed circuit board having a single wiring layer or a plurality of wiring layers, and may be formed of a glass epoxy board, a glass polyimide board, or the like. Elements constituting the control unit 10 including the drive circuit 50 and the control circuit 100 are mounted on the control circuit board 11. Note that the control circuit board 11 on which the elements constituting the control unit 10 are mounted may be a single printed circuit board or a plurality of printed circuit boards.

The control circuit 100 includes a processing circuit such as a CPU or an FPGA and a storage circuit such as a semiconductor memory device. An image information signal including image data is input to the control circuit 100 from an external device such as a host computer disposed outside the liquid ejection apparatus 1. The control circuit 100 generates signals for controlling the elements of the liquid ejection apparatus 1 based on the image information signal input thereto, and then outputs the signals to the corresponding elements.

Specifically, the control circuit 100 generates a clock signal SCK, a latch signal LAT, a change signal CH, an inspection timing signal TSIG, and print data signals SI1 to SIn as the control signals Ctrl-H for controlling the print heads 22-1 to 22-n based on the image information signal input thereto, and then outputs these signals to the head unit 20.

Further, the control circuit 100 generates a base drive signal dA as the control signal Ctrl-H, and then outputs the base drive signal dA to the drive circuit 50. The drive circuit 50 generates a drive signal COM including a signal waveform defined by the base drive signal dA input thereto, and then outputs the drive signal COM to the head unit 20. Specifically, the control circuit 100 generates the base drive signal dA as a digital signal and then outputs the base drive signal dA to the drive circuit 50. The drive circuit 50 performs digital-to-analog signal conversion on the base drive signal dA input thereto, and then performs class-D amplification on the analog signal obtained by the conversion to thereby generate the drive signal COM. Then, the drive circuit 50 outputs the drive signal COM thus generated to the head unit 20. That is, the base drive signal dA output by the control circuit 100 defines the signal waveform of the drive signal COM output by the drive circuit 50. Note that the base drive signal dA is only required to define the signal waveform of the drive signal COM, and may be an analog signal. Further, it is sufficient for the drive circuit 50 to be able to generate the drive signal COM by amplifying a signal waveform defined by the base drive signal dA. Therefore, the drive circuit 50 may generate the drive signal COM by performing class-A amplification, class-B amplification, or class-AB amplification instead of the class-D amplification.

Further, the drive circuit 50 generates a reference voltage signal VBS and then outputs the reference voltage signal VBS to the head unit 20. The reference voltage signal VBS is a signal that is constant in voltage value, and that defines a reference potential for drive of a piezoelectric element 60 provided to an ejection unit 600 described later. The voltage value of such a reference voltage signal VBS may be, for example, the ground potential GND, or may be 5.5 V, 6 V, or the like. Note that in FIG. 2, the illustration is made assuming that the drive circuit 50 generates the reference voltage signal VBS, and outputs the reference voltage signal VBS to the head unit 20, but it is possible for the reference voltage signal VBS to be generated by a power supply circuit or the like not shown and separately configured from the drive circuit 50 and then output to the head unit 20.

Further, a temperature abnormality signal XHOT, temperature information signals TH1 to THn, determination result signals RT1 to RTn, and abnormality information signals Err1 to Errn are input to the control circuit 100 from the head unit 20 described later. The temperature abnormality signal XHOT is a signal representing whether a temperature abnormality has occurred in the print heads 22-1 to 22-n. The temperature information signals TH1 to THn represent the temperatures of the print heads 22-1 to 22-n. The determination result signals RT1 to RTn are signals representing states of the ejection units 600 provided to the print heads 22-1 to 22-n. The abnormality information signals Err1 to Errn are signals representing whether an abnormality has occurred in ejection state determination circuits 300-1 to 300-n described later provided to the head unit 20.

The control circuit 100 corrects or stops the control signals Ctrl-H, Ctrl-C, and Ctrl-T to be output therefrom based on the temperature abnormality signal XHOT, the temperature information signals TH1 to THn, the determination result signals RT1 to RTn, and the abnormality information signals Err1 to Errn input thereto. That is, the liquid ejection apparatus 1 operates in accordance with the temperature of the head unit 20 and the state of the ejection unit 600. This improves the ejection accuracy of the ink ejected from the liquid ejection apparatus 1, and as a result, the quality of the image formed on the medium P is improved. Note that the details of the temperature abnormality signal XHOT, the temperature information signals TH1 to THn, the determination result signals RT1 to RTn, and the abnormality information signals Err1 to Errn input to the control circuit 100 will be described later.

The head unit 20 includes the print heads 22-1 to 22-n, a head wiring board 23, flexible printed circuits (FPC) 24-1 to 24-n, drive signal selection circuits 200-1 to 200-n, and ejection state determination circuits 300-1 to 300-n. Further, each of the print heads 22-1 to 22-n includes the plurality of ejection units 600, and each of the ejection units 600 includes the piezoelectric element 60. The head unit 20 including the print heads 22-1 to 22-n is mounted on the carriage 21.

The head wiring board 23 is a printed circuit board having a single wiring layer or a plurality of wiring layers, and as the head wiring board 23, there can be used, for example, a glass epoxy board or a glass polyimide board. Ejection state determination circuits 300-1 to 300-n are mounted on the head wiring board 23. The flexible wiring board 24-1 has one end electrically coupled to the head wiring board 23 and the other end electrically coupled to the print head 22-1. The drive signal selection circuit 200-1 is mounted on the flexible wiring board 24-1. Similarly, one end of the flexible wiring board 24-i (i represents any one of 1 through n) is electrically coupled to the head wiring board 23, and the other end thereof is electrically coupled to the print head 22-i. The drive signal selection circuit 200-i is mounted on the flexible wiring board 24-i.

Further, one end of a cable 15 is electrically coupled to the head wiring board 23. The other end of the cable 15 is electrically coupled to the control circuit board 11 provided to the control unit 10. The clock signal SCK, the latch signal LAT, the change signal CH, the inspection timing signal TSIG, the print data signals SI1 to SIn, the drive signal COM, and the reference voltage signal VBS output by the control unit 10 propagate through the cable 15 and are input to the head wiring board 23 of the head unit 20. Further, the temperature abnormality signal XHOT, the temperature information signals TH1 to THn, the determination result signals RT1 to RTn, and the abnormality information signals Err1 to Errn output by the head unit 20 propagate through the cable 15 and are input to the control unit 10. Such a cable 15 has a configuration having a sliding property capable of following the movement of the carriage 21, and a flexible flat cable (FCC), for example, can be used as the cable 15.

The clock signal SCK, the latch signal LAT, the change signal CH, the inspection timing signal TSIG, the print data signal SIi, and the drive signal COM that have propagated through the cable 15 propagate through the head wiring board 23 and the flexible wiring board 24-i, and are then input to the drive signal selection circuit 200-i. The drive signal selection circuit 200-i selects or deselects a signal waveform that the drive signal COM has based on the clock signal SCK, the latch signal LAT, the change signal CH, the inspection timing signal TSIG, and the print data signal SIi to thereby generate a drive signal Vin corresponding to each of the ejection units 600 provided to the print head 22-i. Then the drive signal Vin generated by the drive signal selection circuit 200-i is supplied to one end of the piezoelectric element 60 provided to the ejection unit 600 corresponding thereto. On this occasion, the reference voltage signal VBS having propagated through the head wiring board 23 and the flexible wiring board 24-i is supplied in common to the other ends of the piezoelectric elements 60 provided to the plurality of ejection units 600 provided to the print head 22-i. Then, the piezoelectric element 60 provided to the print head 22-i is driven in accordance with a potential difference between the drive signal Vin supplied to the one end and the reference voltage signal VBS supplied to the other end. The ink is ejected from the ejection unit 600 corresponding thereto in accordance with the drive of this piezoelectric element 60.

Further, the drive signal selection circuit 200-i acquires a residual vibration signal Vout corresponding to the residual vibration generated after the piezoelectric element 60 provided to the print head 22-i is driven. The drive signal selection circuit 200-i shapes the signal waveform of the residual vibration signal Vout thus acquired, and then outputs the resultant signal as the residual vibration signal NVTi. The residual vibration signal NVTi output by the drive signal selection circuit 200-i is input to the ejection state determination circuit 300-i.

Further, the drive signal selection circuit 200-i outputs a temperature information signal THi corresponding to the temperature of the print head 22-i that is the temperature of the drive signal selection circuit 200-i. The temperature information signal THi is input to the ejection state determination circuit 300-i, and is at the same time also input to the control circuit 100 after propagating through the cable 15.

The ejection state determination circuit 300-i determines the state of the ejection unit 600 provided to the print head 22-i based on the residual vibration signal NVTi and the temperature information signal THi input thereto. Then, the ejection state determination circuit 300-i generates a determination result signal RTi corresponding to the determination result and then outputs the determination result signal RTi to the control circuit 100. Further, the ejection state determination circuit 300-i generates the abnormality information signal Erri representing whether an abnormality has occurred in the ejection state determination circuit 300-i, and then outputs the abnormality information signal Erri to the control circuit 100.

The drive signal selection circuits 200-1 to 200-n output a temperature abnormality signal XHOT representing whether a temperature abnormality occurs in any one of the drive signal selection circuits 200-1 to 200-n. Specifically, the wiring through which the temperature abnormality signal XHOT representing whether a temperature abnormality has occurred in the drive signal selection circuit 200-1 and the wiring through which the temperature abnormality signal XHOT representing whether a temperature abnormality has occurred in the drive signal selection circuit 200-i are coupled to each other in a wired OR manner. Then, when a temperature abnormality occurs in any one of the drive signal selection circuits 200-1 to 200-n, the drive signal selection circuits 200-1 to 200-n change the logic level of the temperature abnormality signal XHOT propagating through the wiring coupled to each other in the wired OR manner to a predetermined logic level.

In the head unit 20 configured as described above, the print heads 22-1 to 22-n have the same configuration, and are referred to as the print head 22 in some cases when it is unnecessary to distinguish them from each other. Further, the flexible wiring boards 24-1 to 24-n have the same configuration, and are referred to as the flexible wiring board 24 in some cases when it is unnecessary to distinguish them from each other. Further, the drive signal selection circuits 200-1 to 200-n have the same configuration, and are referred to as the drive signal selection circuit 200 in some cases when it is unnecessary to distinguish them from each other. Further, the ejection state determination circuits 300-1 to 300-n have the same configuration, and are referred to as the ejection state determination circuit 300 in some cases when it is unnecessary to distinguish them from each other.

In this case, the clock signal SCK, the latch signal LAT, the change signal CH, the inspection timing signal TSIG, the print data signal as the print data signals SI1 to SIn, and the drive signal COM that have propagated through the head wiring board 23 and the flexible wiring board 24 are input to the drive signal selection circuit 200. Then, the drive signal selection circuit 200 selects or deselects a signal waveform that the drive signal COM includes based on the clock signal SCK, the latch signal LAT, the change signal CH, the inspection timing signal TSIG, and the print data signal SI to thereby generate the drive signals Vin corresponding respectively to the plurality of ejection units 600 provided to the print head 22, and then supplies the drive signals Vin to one ends of the piezoelectric elements 60 that the ejection units 600 corresponding thereto include. On this occasion, the reference voltage signal VBS propagated through the head wiring board 23 and the flexible wiring board 24 is input to the other ends of the piezoelectric elements 60 provided to the plurality of ejection units 600 provided to the print head 22. The piezoelectric elements 60 provided to the plurality of ejection units 600 provided to the print head 22 are driven in accordance with the potential difference between the drive signal Vin supplied to one end and the reference voltage signal VBS supplied to the other end. A corresponding amount of the ink to the drive of the piezoelectric element 60 is ejected from the ejection unit 600 of the print head 22.

Further, the residual vibration signal Vout corresponding to the residual vibration generated after the piezoelectric element 60 provided to the print head 22 is driven is input to the drive signal selection circuit 200. The drive signal selection circuit 200 acquires the residual vibration signal Vout input thereto, and then outputs the residual vibration signal NVT as the residual vibration signals NVT1 to NVTn corresponding to the residual vibration signal Vout thus acquired. The residual vibration signal NVT output by the drive signal selection circuit 200 is input to the ejection state determination circuit 300.

Further, the drive signal selection circuit 200 outputs a temperature information signal TH as the temperature information signals TH1 to THn representing the temperature of the drive signal selection circuit 200. The temperature information signal TH is input to the ejection state determination circuit 300, and is input to the control circuit 100 after propagating through the cable 15.

The ejection state determination circuit 300 determines the state of the ejection unit 600 provided to the print head 22 based on the residual vibration signal NVT and the temperature information signal TH. Then, the description will be presented assuming that the ejection state determination circuit 300 generates the determination result signal RT as the determination result signals RT1 to RTn corresponding to the determination result and the abnormality information signal Err as the abnormality information signals Err1 to Errn representing the presence or absence of abnormality in the ejection state determination circuit 300, and then outputs the determination result signal RT and the abnormality information signal Err to the control circuit 100.

As described above, the liquid ejection apparatus 1 according to the present embodiment includes the head unit 20 that ejects liquid onto the medium P, and the control unit 10 that controls the operation of the head unit 20. Further, the head unit 20 includes the ejection unit 600 that includes the piezoelectric element 60 that is driven by the drive signal COM, and ejects the ink in accordance with the drive of the piezoelectric element 60, the drive signal selection circuit 200 to which the residual vibration signal Vout corresponding to the residual vibration caused by the drive signal COM is input, which outputs the residual vibration signal NVT obtained by shaping the waveform of the residual vibration signal Vout, and which outputs the temperature information signal TH corresponding to the temperature of the drive signal selection circuit 200, and the ejection state determination circuit 300 that determines the state of the ejection unit 600.

### 3. Configuration of Ejection Unit

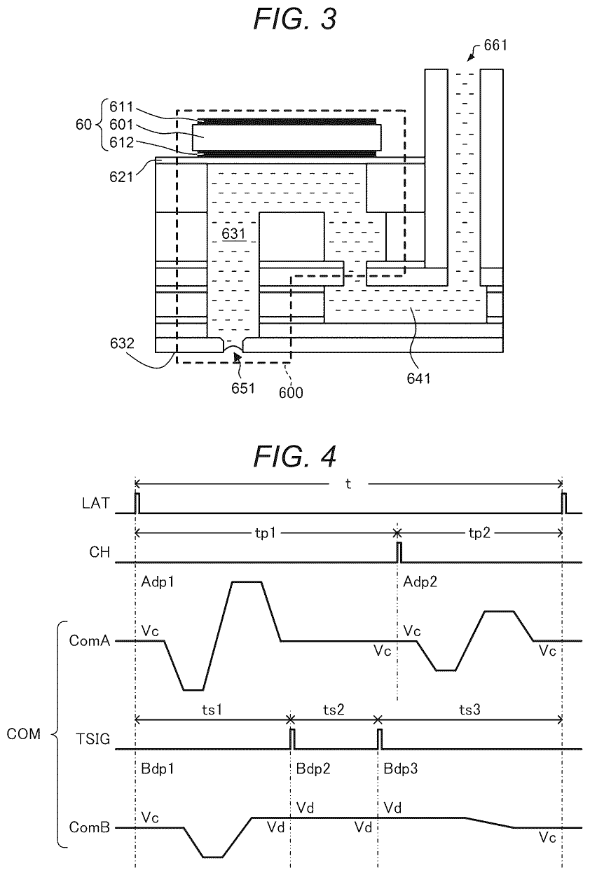

Then, the configuration of the ejection unit 600 provided to the print head 22 will be described. FIG. 3 is a diagram illustrating a schematic configuration of one of the plurality of ejection units 600 provided to the print head 22. As illustrated in FIG. 3, the ejection unit 600 includes the piezoelectric element 60, a vibration plate 621, a cavity 631, and a nozzle 651.

The cavity 631 is filled with the ink supplied from a reservoir 641.

The reservoir 641 is provided in common to the plurality of ejection units 600 provided to the print head 22. Further, to the reservoir 641, the ink is introduced from the ink container 90 via an ink flow path (not shown) and an ink supply port 661. That is, the cavity 631 is filled with the ink stored in the ink container 90.

The vibration plate 621 is displaced by driving the piezoelectric element 60 disposed on an upper surface in FIG. 3. Then, due to the displacement of the vibration plate 621, the internal volume of the cavity 631 to be filled with the ink expands or contracts. That is, the vibration plate 621 functions as a diaphragm that changes the internal volume of the cavity 631.

The nozzle 651 is an opening portion which is provided to a nozzle plate 632 and communicates with the cavity 631. Further, due to a change in the internal volume of the cavity 631, the corresponding amount of the ink to the change in the internal volume is ejected from the nozzle 651.

The piezoelectric element 60 has a structure in which a piezoelectric body 601 is sandwiched between a pair of electrodes 611, 612. In the piezoelectric body 601 having such a structure, central portions of the electrodes 611, 612 bend in the vertical direction together with the vibration plate 621 in accordance with the potential difference between the voltages supplied from the electrodes 611, 612. Specifically, the drive signal Vin is supplied to one of the electrodes 611, 612 of the piezoelectric element 60. Further, a signal at the reference potential serving as a reference for the displacement of the piezoelectric element 60 is supplied to the other of the electrodes 611, 612 of the piezoelectric element 60. Further, for example, when the voltage level of the drive signal Vin increases, the central portion of the piezoelectric element 60 bends upward, and when the voltage level of the drive signal Vin decreases, the central portion thereof bends downward.

In the ejection unit 600 configured as described hereinabove, by driving the piezoelectric element 60 so as to bend upward, the central portion of the vibration plate 621 is displaced upward, and the internal volume of the cavity 631 is increased. As a result, the ink is drawn from the reservoir 641. On the other hand, by driving the piezoelectric element 60 so as to bend downward, the central portion of the vibration plate 621 is displaced downward, and the internal volume of the cavity 631 is reduced. As a result, a corresponding amount of the ink to the degree of reduction is ejected from the nozzle 651.

Note that the piezoelectric element 60 provided to the ejection unit 600 is not limited to the structure shown in FIG. 3, but may have any structure as long as the ink can be ejected from the ejection unit 600. Therefore, the piezoelectric element 60 is not limited to the configuration of the bending vibration described above, and may have a configuration of a longitudinal vibration. Further, the piezoelectric element 60 may have a configuration in which the central portion bends upward when the voltage level of the drive signal Vin decreases, and the central portion bends downward when the voltage level of the drive signal Vin increases.

### 4. Configuration and Operation of Drive Signal Selection Circuit

### 4.1 Signal Waveform of Drive Signal COM

Then, the configuration and the operation of the drive signal selection circuit 200 that outputs the drive signal Vin corresponding to each of the plurality of ejection units 600 provided to the print head 22 by selecting or deselecting the signal waveform that the drive signal COM includes will be described. In describing the details of the drive signal selection circuit 200, an example of a signal waveform of the drive signal COM input to the drive signal selection circuit 200 will be described. FIG. 4 is a diagram illustrating an example of the signal waveform of the drive signal COM. As shown in FIG. 4, the drive signal COM includes a drive signal ComA and a drive signal ComB.

The drive signal ComA includes signal waveforms for expressing four gray levels of a large dot LD, a medium dot MD, a small dot SD, and non-recording ND on the medium P. Specifically, the drive signal ComA includes drive waveforms Adp1, Adp2 as signal waveforms in a period t after the latch signal LAT rises until the latch signal LAT subsequently rises.

The drive waveform Adp1 is arranged in a period tp1 from the rise of the latch signal LAT to a rise of the change signal CH in the period t. The voltage value of the drive waveform Adp1 starts at a voltage Vc, then the voltage value changes so as to drive the piezoelectric element 60, and then the voltage value ends at the voltage Vc. When the drive waveform Adp1 is supplied to one end of the piezoelectric element 60, a predetermined amount of ink is ejected from the nozzle 651 corresponding to that piezoelectric element 60.

The drive waveform Adp2 is arranged in a period tp2 from the rise of the change signal CH to the rise of the latch signal LAT in the period t. The voltage value of the drive waveform Adp2 starts at the voltage Vc, then the voltage value changes so as to drive the piezoelectric element 60, and then the voltage value ends at the voltage Vc. When the drive waveform Adp2 is supplied to one end of the piezoelectric element 60, a smaller amount of ink than a predetermined amount is ejected from the nozzle 651 corresponding to that piezoelectric element 60.

Here, in the following description, in some cases, a predetermined amount of ink ejected from the nozzle 651 corresponding to the piezoelectric element 60 when the drive waveform Adp1 is supplied to one end of that piezoelectric element 60 may be referred to as a medium amount, and an amount of ink ejected from the nozzle 651 that is smaller than the predetermined mount, and that corresponds to when the drive waveform Adp2 is supplied to the one end of the piezoelectric element 60 may be referred to as a small amount.

The drive signal ComB includes signal waveforms for executing an inspection CD of the nozzle 651 as an inspection target out of the plurality of nozzles 651. Specifically, the drive signal ComB includes drive waveforms Bdp1, Bdp2, and Bdp3 as the signal waveforms in the period t.

The drive waveform Bdp1 is arranged in a period ts1 from the rise of the latch signal LAT to a rise of the inspection timing signal TSIG in the period t. The voltage value of the drive waveform Bdp1 starts at a voltage Vc, then the voltage value changes so as to drive the piezoelectric element 60, and then the voltage value ends at a voltage Vd. When the drive waveform Bdp1 is supplied to one end of the piezoelectric element 60, the ink is not ejected from the nozzle 651 corresponding to that piezoelectric element 60, and the piezoelectric element 60 is driven so that a predetermined residual vibration is generated in the ejection unit 600 corresponding to that piezoelectric element 60.

The drive waveform Bdp2 is arranged in a period ts2 from the rise of the inspection timing signal TSIG defining the end of the period ts1 to a subsequent rise of the inspection timing signal TSIG in the period t. The voltage value of the drive waveform Bdp2 is constant at the voltage Vd. When the drive waveform Bdp2 is supplied to one end of the piezoelectric element 60, the piezoelectric element 60 is not driven, and accordingly the ink is not ejected from the nozzle 651 corresponding to that piezoelectric element 60.

A drive waveform Bdp3 is arranged in a period ts3 from the rise of the inspection timing signal TSIG defining the end of the period ts2 to a subsequent rise of the latch signal LAT in the period t. The drive waveform Bdp3 starts with the voltage value at the voltage Vd, and is then terminated when the voltage value becomes the voltage Vc. When the drive waveform Bdp3 is supplied to one end of the piezoelectric element 60, the piezoelectric element 60 is not driven, and accordingly the ink is not ejected from the nozzle 651 corresponding to that piezoelectric element 60.

That is, the drive circuit 50 outputs the drive signal COM to the drive signal selection circuit 200, the drive signal COM including the drive signal ComA including the drive waveforms Adp1, Adp2 for expressing the four gray levels of the large dot LD, the medium dot MD, the small dot SD, and the non-recording ND on the medium P, and the drive signal ComB including the drive waveforms Bdp1, Bdp2, and Bdp3 for executing the inspection CD of the ejection unit 600 including the nozzle 651 as the inspection target.

Note that the signal waveform of the drive signal COM shown in FIG. 4 is illustrative only, and the drive signal COM may include signal waveforms of various shapes corresponding to the moving speed of the carriage 21 on which the print heads 22 are mounted, the type of the medium P on which the ink lands, the characteristics of the ink, and so on.

### 4.2 Configuration of Drive Signal Selection Circuit

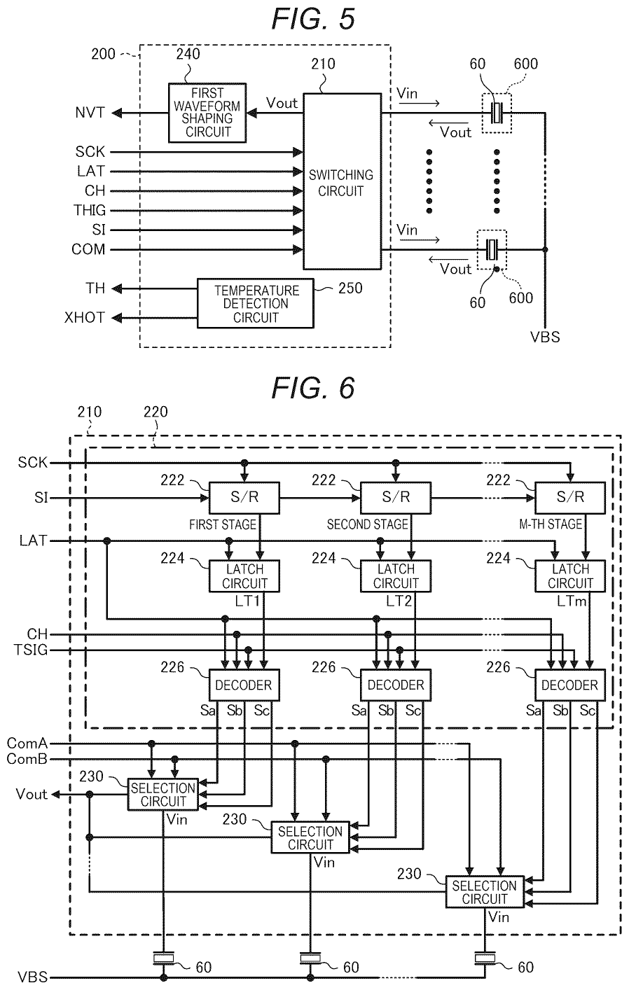

Then, the configuration of the drive signal selection circuit 200 that generates the drive signal Vin by selecting or deselecting the signal waveform provided to the drive signal COM and then outputs the drive signal Vin to the ejection unit 600 corresponding thereto will be described. FIG. 5 is a diagram illustrating an example of a functional configuration of the drive signal selection circuit 200. As illustrated in FIG. 5, the drive signal selection circuit 200 includes a switching circuit 210, a first waveform shaping circuit 240, and a temperature detection circuit 250. Such a drive signal selection circuit 200 is configured as a single semiconductor device, and is COF (Chip On Film)-mounted on the flexible wiring board 24.

The clock signal SCK, the latch signal LAT, the change signal CH, the inspection timing signal TSIG, the print data signal SI, and the drive signal COM are input to the switching circuit 210. The switching circuit 210 selects or deselects the drive waveforms Adp1 and Adp2 provided to the drive signal ComA in the drive signal COM and the drive waveforms Bdp1, Bdp2, and Bdp3 provided to the drive signal ComB in the drive signal COM based on the input clock signal SCK, the latch signal LAT, the inspection timing signal TSIG, the change signal CH, and the print data signal SI to thereby generate the drive signal Vin corresponding to each of the plurality of ejection units 600, and then output the drive signal Vin to the ejection unit 600 corresponding thereto.

In addition, after the piezoelectric element 60 is driven by the drive signal Vin output by the switching circuit 210, the switching circuit 210 acquires the residual vibration signal Vout corresponding to the residual vibration generated in the ejection unit 600 due to the drive of the piezoelectric element 60. The switching circuit 210 outputs the residual vibration signal Vout thus acquired to the first waveform shaping circuit 240.

The first waveform shaping circuit 240 shapes the signal waveform of the residual vibration signal Vout by extracting an AC component from the residual vibration signal Vout input thereto and amplifying the AC component, and then outputs the result as the residual vibration signal NVT. The residual vibration signal NVT output by the first waveform shaping circuit 240 is output from the drive signal selection circuit 200.

The temperature detection circuit 250 detects the temperature of the semiconductor device including the drive signal selection circuit 200 including the switching circuit 210 and the first waveform shaping circuit 240. Then, the temperature detection circuit 250 generates a temperature information signal TH of a voltage value corresponding to the detection result of the temperature, and then outputs the temperature information signal TH from the drive signal selection circuit 200. Further, the temperature detection circuit 250 determines whether the temperature of the semiconductor device including the drive signal selection circuit 200 is equal to or higher than a predetermined threshold value. Then, when the temperature of the semiconductor device including the drive signal selection circuit 200 is equal to or higher than the predetermined threshold value, the temperature detection circuit 250 determines that a temperature abnormality has occurred in the semiconductor device including the drive signal selection circuit 200, and outputs the temperature abnormality signal XHOT in the logic level representing the temperature abnormality of the semiconductor device including the drive signal selection circuit 200.

As described above, the drive signal selection circuit 200 includes the first waveform shaping circuit 240 and the temperature detection circuit 250, wherein the residual vibration signal Vout corresponding to the residual vibration caused by the drive signal COM is input to the first waveform shaping circuit 240, the first waveform shaping circuit 240 outputs the residual vibration signal NVT obtained by shaping the signal waveform of the residual vibration signal Vout, the temperature detection circuit 250 outputs the temperature information signal TH corresponding to the temperature of the first waveform shaping circuit 240, and the first waveform shaping circuit 240 and the temperature detection circuit 250 are provided to a single semiconductor device.

### 4.2.1 Configuration of Switching Circuit

A specific example of a configuration and an operation of the switching circuit 210 provided to the drive signal selection circuit 200 will be described. FIG. 6 is a diagram illustrating an example of a functional configuration of the switching circuit 210. As illustrated in FIG. 6, the switching circuit 210 includes a selection control circuit 220 and a plurality of selection circuits 230.

The clock signal SCK, the print data signal SI, the latch signal LAT, the change signal CH, and the inspection timing signal TSIG are input to the selection control circuit 220. Based on the clock signal SCK, the print data signal SI, the latch signal LAT, the change signal CH, and the inspection timing signal TSIG input thereto, the selection control circuit 220 generates selection signals Sa, Sb, and Sc having predetermined logic levels in each of the periods tp1, tp2 and the periods ts1, ts2, ts3, and then outputs the selection signals Sa, Sb, and Sc to the selection circuits 230 corresponding thereto.

The selection control circuit 220 includes a set of a shift register 222, a latch circuit 224, and a decoder 226 provided corresponding respectively to the piezoelectric elements 60 provided to the plurality of ejection units 600 provided to the print head 22. Here, in the following description, it is assumed that the print head 22 incudes the m ejection units 600 and therefore includes the m piezoelectric elements 60. That is, the selection control circuit 220 includes m sets of the shift register 222, the latch circuit 224, and the decoder 226. In other words, the selection control circuit 220 includes the m shift registers 222, the m latch circuits 224, and the m decoders 226.

The print data signal SI serially includes 3-bit print data SId [SIH, SIM, SIL] for selecting which one of patterns, namely the large dot LD, the medium dot MD, the small dot SD, the non-recording ND, and the inspection CD, the piezoelectric element 60 is to be driven to generate, in accordance with each of the m piezoelectric elements 60. That is, the print data signal SI is a serial signal of 3m bits or more in total.

The print data signal SI is input to the selection control circuit 220 in synchronization with the clock signal SCK. The m shift registers 222 provided to the selection control circuit 220 hold the 3-bit print data SId [SIH, SIM, SIL] provided to the print data signal SI input thereto so as to correspond to the piezoelectric elements 60.

Particularly, the m shift registers 222 are serially coupled so as to correspond respectively to the m piezoelectric elements 60. The print data signal SI serially input to the selection control circuit 220 is sequentially transferred to the subsequent stages of the m shift registers 222 serially coupled in synchronization with the clock signal SCK. Then, when the supply of the clock signal SCK to the selection control circuit 220 is stopped, the 3-bit print data SId [SIH, SIM, SIL] corresponding to the m piezoelectric elements 60 are held in the m shift registers 222. Note that in the following description, in order to distinguish the m shift registers 222 serially coupled from each other, the m shift registers 222 may be referred to as a first stage, a second stage, and an m-th stage in this order from the upstream to the downstream in a direction in which the print data signal SI is supplied.

Each of the m latch circuits 224 latches the 3-bit print data SId [SIH, SIM, SIL] held in the corresponding shift register 222 simultaneously at the rising edge of the latch signal LAT.

Then, the print data SId [SIH, SIM, SIL] latched by the m latch circuits 224 is input to the corresponding decoders 226. Each of the m decoders 226 decodes the print data SId [SIH, SIM, SIL] input thereto to generate the selection signals Sa, Sb, and Sc having the logic levels corresponding to the large dot LD, the medium dot MD, the small dot SD, the non-recording ND, and the inspection CD, and then outputs the selection signals Sa, Sb, and Sc to the selection circuit 230 corresponding thereto.

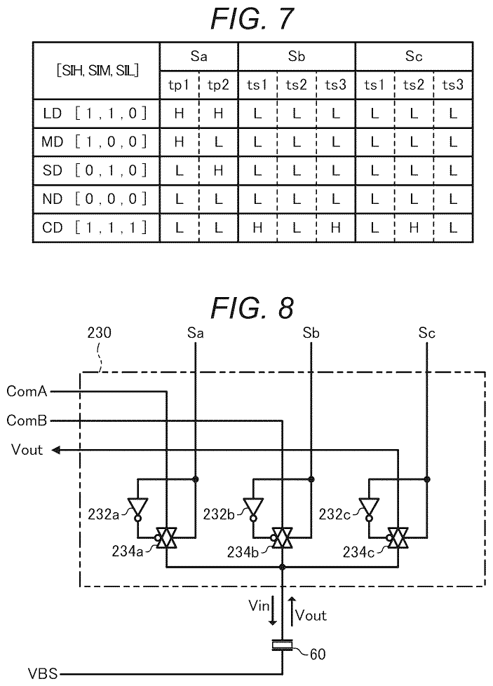

FIG. 7 is a diagram illustrating an example of decoding contents in the decoder 226. As shown in FIG. 7, when the print data SId [SIH, SIM, SIL]=[1, 1, 0] corresponding to the large dot LD is input, the decoder 226 sets the logic level of the selection signal Sa to H, H levels in the periods tp1, tp2, sets the logic level of the selection signal Sb to L, L, and L levels in the periods ts1, ts2, and ts3, and sets the logic level of the selection signal Sc to L, L, and L levels in the periods ts1, ts2, and ts3.

Further, when the print data SId [SIH, SIM, SIL]=[1, 0, 0] corresponding to the medium dot MD is input, the decoder 226 sets the logic level of the selection signal Sa to H, L levels in the periods tp1, tp2, sets the logic level of the selection signal Sb to L, L, and L levels in the periods ts1, ts2, and ts3, and sets the logic level of the selection signal Sc to L, L, and L levels in the periods ts1, ts2, and ts3.

Further, when the print data SId [SIH, SIM, SIL]=[0, 1, 0] corresponding to the small dot SD is input, the decoder 226 sets the logic level of the selection signal Sa to L, H levels in the periods tp1, tp2, sets the logic level of the selection signal Sb to L, L, and L levels in the periods ts1, ts2, and ts3, and sets the logic level of the selection signal Sc to L, L, and L levels in the periods ts1, ts2, and ts3.

When the print data SId [SIH, SIM, SIL]=[0, 0, 0] corresponding to the non-recording ND is input, the decoder 226 sets the logic level of the selection signal Sa to L, L levels in the periods tp1, tp2, sets the logic level of the selection signal Sb to L, L, and L levels in the periods ts1, ts2, and ts3, and sets the logic level of the selection signal Sc to L, L, and L levels in the periods ts1, ts2, and ts3.

Further, when the print data SId [SIH, SIM, SIL]=[1, 1, 1] corresponding to the inspection SD is input, the decoder 226 sets the logic level of the selection signal Sa to L, L levels in the periods tp1, tp2, sets the logic level of the selection signal Sb to H, L, and H levels in the periods ts1, ts2, and ts3, and sets the logic level of the selection signal Sc to L, H, and L levels in the periods ts1, ts2, and ts3.

As described above, based on the print data SId [SIH, SIM, SIL], the selection control circuit 220 generates the selection signals Sa, Sb, and Sc of the logic levels corresponding to the piezoelectric elements 60 provided respectively to the m ejection units 600. Then, the selection control circuit 220 outputs the selection signals Sa, Sb, and Sc thus generated to the corresponding selection circuits 230.

The selection circuit 230 is provided corresponding to each of the m piezoelectric elements 60. That is, the switching circuit 210 includes the m selection circuits 230. FIG. 8 is a diagram illustrating a configuration of the selection circuit 230 corresponding to one of the piezoelectric elements 60. As illustrated in FIG. 8, the selection circuit 230 includes logic inversion circuits 232a, 232b, and 232c and transfer gates 234a, 234b, and 234c.

The selection signal Sa is supplied to a positive control terminal of the transfer gate 234a, and is inverted in logic level by the logic inversion circuit 232a, and is then also supplied to a negative control terminal of the transfer gate 234a. The selection signal Sb is supplied to a positive control terminal of the transfer gate 234b, and is inverted in logic level by the logic inversion circuit 232b, and is then also supplied to a negative control terminal of the transfer gate 234b. The selection signal Sc is supplied to a positive control terminal of the transfer gate 234c, and is inverted in logic level by the logic inversion circuit 232c, and is then also supplied to a negative control terminal of the transfer gate 234c.

Further, the drive signal ComA is supplied to an input terminal of the transfer gate 234a, and the drive signal ComB is supplied to an input terminal of the transfer gate 234b. Further, output terminals of the transfer gates 234a, 234b are coupled to each other. The output terminals of the transfer gates 234a, 234b coupled to each other are electrically coupled to one end of the corresponding piezoelectric element 60. Further, an input terminal of the transfer gate 234c is electrically coupled to the output terminals of the transfer gates 234a, 234b coupled to each other and the one end of the piezoelectric element 60. As shown in FIG. 6, output terminals of the transfer gates 234c of the m selection circuits 230 provided to the switching circuit 210 are commonly coupled to each other.

In the selection circuit 230 configured as described hereinabove, when the logic level of the selection signal Sa is at the H level, the transfer gate 234a becomes conductive between the input terminal and the output terminal, and when the logic level of the selection signal Sa is at the L level, the transfer gate 234a becomes non-conductive between the input terminal and the output terminal. Further, when the logic level of the selection signal Sb is at the H level, the transfer gate 234b becomes conductive between the input terminal and the output terminal, and when the logic level of the selection signal Sb is at the L level, the transfer gate 234b becomes non-conductive between the input terminal and the output terminal. Further, when the logic level of the selection signal Sc is at the H level, the transfer gate 234c becomes conductive between the input terminal and the output terminal, and when the logic level of the selection signal Sc is at the L level, the transfer gate 234c becomes non-conductive between the input terminal and the output terminal. Here, in the following description, the conductive state between the input terminal and the output terminal may be referred to as “ON”, and the non-conductive state between the input terminal and the output terminal may be referred to as “OFF”, in some cases.

Then, when the transfer gate 234a is turned on, the drive signal ComA is output from the switching circuit 210 as the drive signal Vin, and when the transfer gate 234b is turned on, the drive signal ComB is output from the switching circuit 210 as the drive signal Vin. The drive signal Vin output from the switching circuit 210 is supplied to one end of the piezoelectric element 60 provided to the corresponding ejection unit 600. Further, by the transfer gate 234c being turned on, the switching circuit 210 acquires the residual vibration signal Vout corresponding to the residual vibration generated in the ejection unit 600 in accordance with the drive of the piezoelectric element 60. Then, the switching circuit 210 outputs the residual vibration signal Vout thus acquired to the first waveform shaping circuit 240.

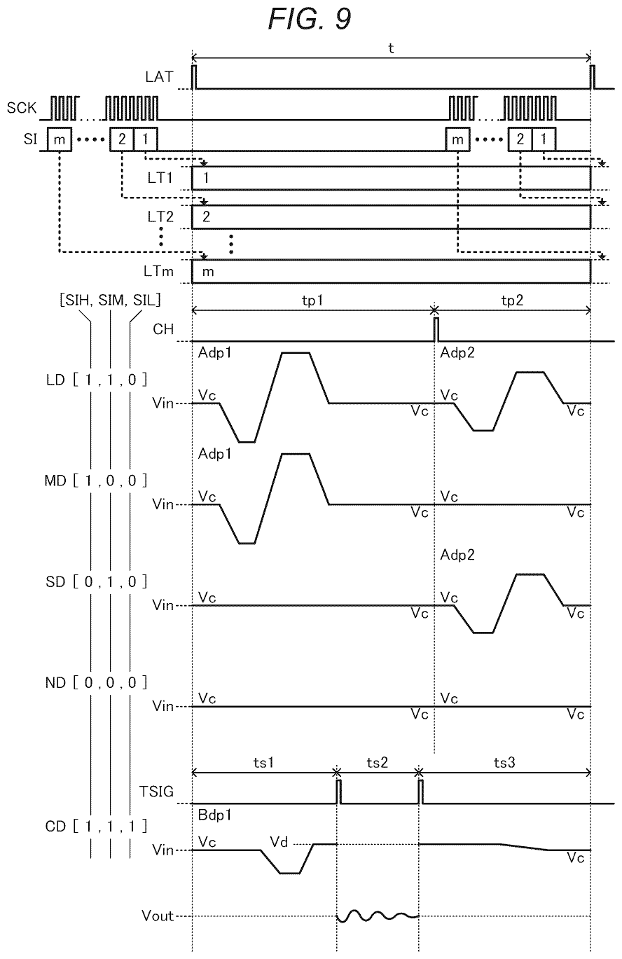

The details of the operation of the switching circuit 210 configured as described above will be described. FIG. 9 is a diagram illustrating an example of the operation of the switching circuit 210. The print data signal SI is serially supplied to the switching circuit 210 in synchronization with the clock signal SCK. The print data signal SI input to the switching circuit 210 is sequentially transferred to the shift registers 222 in the subsequent stages in synchronization with the clock signal SCK. Then, when the supply of the clock signal SCK to the switching circuit 210 is stopped, the 3-bit print data SId [SIH, SIM, SIL] corresponding to the m ejection units 600 is held in the m shift registers 222.

When the latch signal LAT rises, each of the latch circuits 224 simultaneously latches the print data SId [SIH, SIM, SIL] held in the shift register 222. Here, LT1, LT2, . . . , LTm shown in FIG. 9 represent the print data SId [SIH, SIM, SIL] which is held by the shift registers 222 in the first stage, the second stage, . . . , and the m-th stage and then latched by the corresponding latch circuits 224.

The decoder 226 decodes the print data SId [SIH, SIM, SIL] thus latched with the contents shown in FIG. 7. Then, the decoder 226 outputs selection signals Sa, Sb, Sc at the logic levels shown in FIG. 7 in the period t.

Specifically, in the case of the print data SId [SIH, SIM, SIL]=[1, 1, 0], the decoder 226 sets the logic level of the selection signal Sa to H, H levels in the periods tp1, tp2, sets the logic level of the selection signal Sb to L, L, and L levels in the periods ts1, ts2, and ts3, and sets the logic level of the selection signal Sc to L, L, and L levels in the periods ts1, ts2, and ts3. Accordingly, the selection circuit 230 selects the drive waveform Adp1 of the drive signal ComA in the period tp1, and selects the drive waveform Adp2 of the drive signal ComA in the period tp2. As a result, the switching circuit 210 outputs the drive signal Vin corresponding to the large dot LD shown in FIG. 9. When the drive signal Vin corresponding to the large dot LD is supplied to one end of the piezoelectric element 60, the medium amount of ink is ejected from the corresponding nozzle 651 in the period tp1, and the small amount of ink is ejected in the period tp2. As a result, in the period t, the medium amount of ink and the small amount of ink land on the medium P and are combined with each other. Thus, the large dot LD is formed on the medium P.

In the case of the print data SId [SIH, SIM, SIL]=[1, 0, 0], the decoder 226 sets the logic level of the selection signal Sa to H, L levels in the periods tp1, tp2, sets the logic level of the selection signal Sb to L, L, and L levels in the periods ts1, ts2, and ts3, and sets the logic level of the selection signal Sc to L, L, and L levels in the periods ts1, ts2, and ts3. Accordingly, the selection circuit 230 selects the drive waveform Adp1 of the drive signal ComA in the period tp1, and does not select any of the drive signals ComA, ComB in the period tp2. As a result, the switching circuit 210 outputs the drive signal Vin corresponding to the medium dot MD shown in FIG. 9. When the drive signal Vin corresponding to the medium dot MD is supplied to one end of the piezoelectric element 60, the medium amount of ink is ejected from the corresponding nozzle 651 in the period tp1, and the ink is not ejected in the period tp2. As a result, the medium amount of ink lands on the medium P in the period t. Accordingly, the medium dot MD is formed on the medium P.

In the case of the print data SId [SIH, SIM, SIL]=[0, 1, 0], the decoder 226 sets the logic level of the selection signal Sa to L, H levels in the periods tp1, tp2, sets the logic level of the selection signal Sb to L, L, and L levels in the periods ts1, ts2, and ts3, and sets the logic level of the selection signal Sc to L, L, and L levels in the periods ts1, ts2, and ts3. Accordingly, the selection circuit 230 does not select any signal waveform of the drive signals ComA, ComB in the period tp1, and selects the drive waveform Adp2 of the drive signal ComA in the period tp2. As a result, the switching circuit 210 outputs the drive signal Vin corresponding to the small dot SD shown in FIG. 9. When the drive signal Vin corresponding to the small dot SD is supplied to one end of the piezoelectric element 60, the ink is not ejected from the corresponding nozzle 651 in the period tp1, and the small amount of ink is ejected in the period tp2. As a result, the small amount of ink lands on the medium P in the period t. As a result, the small dot SD is formed on the medium P.

In the case of the print data SId [SIH, SIM, SIL]=[0, 0, 0], the decoder 226 sets the logic level of the selection signal Sa to L, L levels in the periods tp1, tp2, sets the logic level of the selection signal Sb to L, L, and L levels in the periods ts1, ts2, and ts3, and sets the logic level of the selection signal Sc to L, L, and L levels in the periods ts1, ts2, and ts3. Accordingly, the selection circuit 230 does not select any signal waveform of the drive signals ComA, ComB in the period tp1, and does not select any waveform of the drive signals ComA, ComB in the period tp2. As a result, the switching circuit 210 outputs the drive signal Vin corresponding to the non-recording ND illustrated in FIG. 9. When the drive signal Vin corresponding to the non-recording ND is supplied to one end of the piezoelectric element 60, the ink is not ejected from the corresponding ejection unit 600 in the period tp1, and the ink is not ejected therefrom in the period tp2. As a result, the ink does not land on the medium P in the period t. Therefore, no dots are formed on the medium P.

In the case of the print data SId [SIH, SIM, SIL]=[1, 1, 1], the decoder 226 sets the logic level of the selection signal Sa to L, L levels in the periods tp1, tp2, sets the logic level of the selection signal Sb to H, L, and H levels in the periods ts1, ts2, and ts3, and sets the logic level of the selection signal Sc to L, H, and L levels in the periods ts1, ts2, and ts3. Accordingly, the selection circuit 230 selects the drive waveform Bdp1 of the drive signal ComB in the period ts1, then acquires the residual vibration signal Vout in accordance with the residual vibration of the ejection unit 600 and outputs the residual vibration signal Vout thus acquired from the switching circuit 210 in the period ts2, and then selects the drive waveform Bdp3 of the drive signal ComB in the period ts3. As a result, the switching circuit 210 outputs the drive signal Vin corresponding to the inspection CD shown in FIG. 9 in the periods ts1, ts3, acquires the residual vibration signal Vout corresponding to the residual vibration generated after the drive waveform Bdp1 is supplied to the piezoelectric element 60 and outputs the residual vibration signal Vout to the first waveform shaping circuit 240 in the period ts2. On this occasion, the ink is not ejected from the corresponding nozzle 651 in the period t. Therefore, in the cycle t, the ink does not land on the medium P. Therefore, no dots are formed on the medium P.

As described above, the switching circuit 210 generates the drive signal Vin by selecting or deselecting the drive waveforms Adp1, Adp2 provided to the drive signal ComA and the drive waveforms Bdp1, Bdp2, and Bdp3 provided to the drive signal ComB in the drive signal COM output by the drive circuit 50 based on the clock signal SCK, the print data signal SI, the latch signal LAT, the change signal CH, and the inspection timing signal TSIG. Then, the switching circuit 210 supplies the drive signal Vin thus generated to the corresponding piezoelectric element 60, then acquires the residual vibration signal Vout corresponding to the residual vibration generated after the piezoelectric element 60 is driven in accordance with the drive signal Vin, and then outputs the residual vibration signal Vout to the first waveform shaping circuit 240.

### 4.2.2 Configuration of First Waveform Shaping Circuit

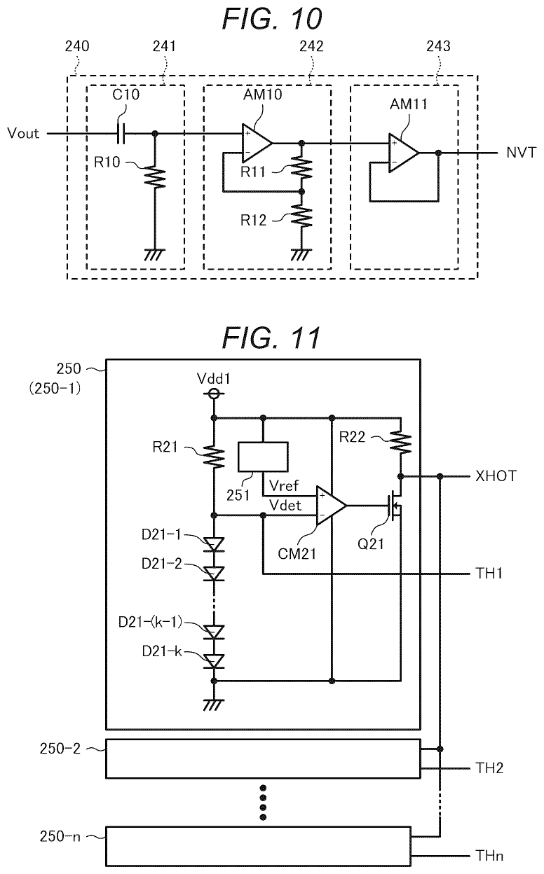

Then, a specific example of the configuration and the operation of the first waveform shaping circuit 240 provided to the drive signal selection circuit 200 will be described. FIG. 10 is a diagram illustrating an example of the configuration of the first waveform shaping circuit 240. As illustrated in FIG. 10, the first waveform shaping circuit 240 includes a filter circuit 241, a non-inverting amplifier circuit 242, and an impedance conversion circuit 243.

The filter circuit 241 includes a capacitor C10 and a resistor R10. A residual vibration signal Vout is supplied to one end of the capacitor C10. The other end of the capacitor C10 is electrically coupled to one end of the resistor R10. The ground potential is supplied to the other end of the resistor R10. The filter circuit 241 configured as described above constitutes a high-pass filter that extracts a high frequency component superimposed on the residual vibration signal Vout. That is, the filter circuit 241 reduces the low frequency component superimposed on the residual vibration signal Vout. Note that the filter circuit 241 may include a low-pass filter in addition to the high-pass filter.

The non-inverting amplifier circuit 242 includes an operational amplifier AMP10 and resistors R11, R12. A signal output by the filter circuit 241 is input to a positive input terminal of the operational amplifier AM10. A negative input terminal of the operational amplifier AM10 is electrically coupled to one end of the resistor R11 and one end of the resistor R12. The other end of the resistor R11 is electrically coupled to an output terminal of the operational amplifier AM10. The ground potential is supplied to the other end of the resistor R12. The non-inverting amplifier circuit 242 configured as described above constitutes a non-inverting amplifier circuit that amplifies the signal output by the filter circuit 241 input to the positive input terminal of the operational amplifier AM10 at a gain defined by the resistance values of the resistors R11, R12. In other words, the non-inverting amplifier circuit 242 extracts the AC component of the residual vibration signal Vout, and amplifies the amplitude of the signal thus extracted with the gain defined by the resistance values of the resistors R11, R12.

The impedance conversion circuit 243 includes an operational amplifier AM11. The signal output by the non-inverting amplifier circuit 242 is input to the positive input terminal of the operational amplifier AM11. In addition, the negative input terminal of the operational amplifier AM11 is electrically coupled to an output terminal of the operational amplifier AM11. The impedance conversion circuit 243 configured as described above constitutes a so-called voltage follower circuit that outputs a signal having the same signal waveform as the signal waveform of the signal input to the positive input terminal of the operational amplifier AM11 from the output terminal of the operational amplifier AM11.

Then, the first waveform shaping circuit 240 outputs, as the residual vibration signal NVT, a signal that is the signal output from the output terminal of the operational amplifier AM10 provided to the non-inverting amplifier circuit 242, and is the signal output from the output terminal of the operational amplifier AM11 provided to the impedance conversion circuit 243.

As described above, the first waveform shaping circuit 240 generates the residual vibration signal NVT obtained by shaping the waveform of the residual vibration signal Vout by the filter circuit 241 removing the noise and the DC component of the low frequency component of the residual vibration signal Vout, and the non-inverting amplifier circuit 242 amplifying the amplitude of the residual vibration signal Vout from which the low frequency component such as the DC component is removed. Specifically, the first waveform shaping circuit 240 includes the operational amplifier AM10 that amplifies the residual vibration signal Vout and then outputs the result as the residual vibration signal NVT, and resistors R11, R12 that set the gain of the operational amplifier AM10.

On this occasion, the operational amplifier AM10 and the resistors R11, R12 provided to the first waveform shaping circuit 240 are configured as a single semiconductor device provided with the drive signal selection circuit 200. Although described later in detail, the residual vibration signal Vout that corresponds to the residual vibration of the ejection unit 600 as the inspection target, and that corresponds to the residual vibration output by the switching circuit 210 includes a signal of electromotive force generated by the displacement of the piezoelectric element 60 caused by the residual vibration generated in the ejection unit 600 after the drive signal COM is supplied to the piezoelectric element 60. Accordingly, the residual vibration signal Vout corresponding to the residual vibration is signal of a weak attenuating vibration and is easily affected by noise. In the first waveform shaping circuit 240 of the present embodiment, by the filter circuit 241 removing the noise and the DC component of the low frequency component from the residual vibration signal Vout to thereby extract the AC component caused by the attenuating vibration generated in the ejection unit 600 as the inspection target, the waveform accuracy of the residual vibration signal Vout is improved. Further, by the non-inverting amplifier circuit 242 amplifying the signal improved in waveform accuracy by the filter circuit 241, the resistance to noise is enhanced. That is, the first waveform shaping circuit 240 outputs the residual vibration signal NVT that is obtained by shaping the signal waveform of the residual vibration signal Vout, and that is enhanced in resistance to noise.

On this occasion, the impedance conversion circuit 243 converts the impedance of the residual vibration signal NVT output by the non-inverting amplifier circuit 242. Accordingly, it is possible to improve the stability of the residual vibration signal NVT output by the first waveform shaping circuit 240, and it is also possible to reduce the possibility that an erroneous operation occurs in the ejection unit 600 due to the operation of the ejection state determination circuit 300 when determining the state of the ejection unit 600 based on the residual vibration signal NVT.

By such a first waveform shaping circuit 240 being configured as the single semiconductor device together with the switching circuit 210, it is possible to amplify the residual vibration signal Vout in the vicinity of the ejection unit 600 including the piezoelectric element 60. That is, the propagation path of the residual vibration signal Vout can be shortened. As a result, the possibility that the noise is superimposed on the residual vibration signal Vout that is a signal of the weak attenuating vibration, and that corresponds to the residual vibration is further reduced, and it is possible to increase the waveform accuracy of the residual vibration signal Vout to be acquired by the first waveform shaping circuit 240. As a result, the waveform accuracy of the residual vibration signal NVT output by the drive signal selection circuit 200 is improved.

### 4.2.3 Configuration of Temperature Detection Circuit

Then, a specific example of the configuration and the operation of the temperature detection circuit 250 will be described. FIG. 11 is a diagram illustrating an example of the configuration of the temperature detection circuit 250. Here, the drive signal selection circuits 200-1 to 200-n have substantially the same configuration as one another. Therefore, the temperature detection circuits 250 provided to the respective drive signal selection circuits 200-1 to 200-n have substantially the same configurations. Therefore, in the following description, when describing the temperature detection circuits 250 provided to the respective drive signal selection circuits 200-1 to 200-n distinguished from each other, the temperature detection circuit 250 provided to the drive signal selection circuit 200-1 is referred to as a temperature detection circuit 250-1, and the temperature detection circuit 250 provided to the drive signal selection circuit 200-n is referred to as a temperature detection circuit 250-n in some cases.

FIG. 11 is a diagram illustrating an example of the configuration of the temperature detection circuit 250. As illustrated in FIG. 11, the temperature detection circuit 250 includes a reference voltage generation circuit 251, a comparator CM21, a transistor Q21, diodes D21-1 to D21-k, and resistors R21, R22. Further, a voltage signal Vdd1 having a constant voltage value is supplied to the temperature detection circuit 250. The voltage signal Vdd1 input to the temperature detection circuit 250 may be generated based on a bandgap reference of a semiconductor device including the temperature detection circuit 250, or may be generated by a power supply circuit (not shown) disposed outside the temperature detection circuit 250.

The voltage signal Vdd1 input to the temperature detection circuit 250 is input to the reference voltage generation circuit 251, one end of the resistor R21, and one end of the resistor R22. The reference voltage generation circuit 251 transforms the voltage value of the voltage signal Vdd1 input thereto to thereby generate a voltage signal Vref having a constant voltage value. Then, the voltage signal Vref generated by the reference voltage generation circuit 251 is input to a positive input terminal of the comparator CM21. Further, the other end of the resistor R21 is electrically coupled to an anode terminal of the diode D21-1. A cathode terminal of the diode D21-1 is electrically coupled to an anode terminal of the diode D21-2, a cathode terminal of the diode D21-2 is electrically coupled to an anode terminal of the diode D21-3, and a cathode terminal of the diode D21-i (i is one of 1 through k−1) is electrically coupled to an anode terminal of the diode D21-(i+1). That is, the diodes D21-1 to D21-k are coupled in series to each other. On this occasion, the anode terminal of the diode D21-1 disposed at one end portion of the diodes D21-1 to D21-k coupled in series to each other is electrically coupled to the other end of the resistor R21, and the ground potential is supplied to the cathode terminal of the diode D21-k disposed at the other end portion of the diodes D21-1 to D21-k coupled in series to each other.

Then, a signal of a connection point at which the other end of the resistor R21 and the anode terminal of the diode D21-1 are electrically coupled to each other, the signal having a voltage value representing the sum of the forward voltages of the diodes D21-1 to D21-k coupled in series to each other is input to a negative input terminal of the comparator CM21 as a voltage signal Vdet, and is output from the temperature detection circuit 250 as the temperature information signal TH.

The comparator CM21 operates using a potential difference between the voltage signal Vdd1 supplied to a high-voltage-side power supply terminal and a signal of the ground potential supplied to a low-voltage-side power supply terminal as a drive source. An output terminal of the comparator CM21 is electrically coupled to a gate terminal of the transistor Q21. A drain terminal of the transistor Q21 is electrically coupled to the other end of the resistor R22, and the ground potential is supplied to a source terminal of the transistor Q21. Further, a signal of the drain terminal of the transistor Q21 is output from the temperature detection circuit 250 as the temperature abnormality signal XHOT.

In the temperature detection circuit 250 configured as described above, the voltage values of the forward voltages of the respective diodes D21-1 to D21-k decrease when the temperature of the diodes D21-1 to D21-k rises. That is, the voltage value of the voltage signal Vdet and the voltage value of the temperature information signal TH vary in accordance with the temperatures of the diodes D21-1 to D21-k, namely the temperature of the semiconductor device constituting the drive signal selection circuit 200 including the diodes D21-1 to D21-k. In other words, the temperature detection circuit 250 outputs the temperature information signal TH corresponding to the temperature of the semiconductor device constituting the drive signal selection circuit 200 including the switching circuit 210, the first waveform shaping circuit 240, and the temperature detection circuit 250.

The voltage signal Vdet having the voltage value corresponding to the temperatures of the diodes D21-1 to D21-k, namely the temperature of the semiconductor device constituting the drive signal selection circuit 200 including the diodes D21-1 to D21-k is also input to the negative input terminal of the comparator CM21. The comparator CM21 compares the voltage value of the voltage signal Vref input to the positive input terminal and the voltage value of the voltage signal Vdet input to the negative input terminal with each other. Further, the comparator CM21 outputs a signal at the L level having the ground potential when the voltage value of the voltage signal Vdet is higher than the voltage value of the voltage signal Vref, and outputs a signal at the H level having the voltage value of the voltage signal Vdd1 when the voltage value of the voltage signal Vdet is lower than the voltage value of the voltage signal Vref.

Here, the voltage value of the voltage signal Vref output by the reference voltage generation circuit 251 is set to, for example, the voltage value of the voltage signal Vdet input to the comparator CM21 when the temperatures of the diodes D21-1 to D21-k are the highest in the temperature range in which the diodes D21-1 to D21-k can operate stably. That is, when the temperatures of the diodes D21-1 to D21-k are within the temperature range in which the diodes D21-1 to D21-k can operate stably, the comparator CM21 outputs a signal at the L level, and when the temperatures of the diodes D21-1 to D21-k exceed the temperature range in which the diodes D21-1 to D21-k can operate stably, the comparator CM21 outputs a signal at the H level. Note that it is sufficient for the voltage value of the voltage signal Vref output by the reference voltage generation circuit 251 to be a voltage value with which whether the temperatures of the diodes D21-1 to D21-k and the temperature of the semiconductor device including the diodes D21-1 to D21-k are normal can be determined, and is not limited to when being defined based on the temperature range in which the diodes D21-1 to D21-k can operate stably.

The signal output by the comparator CM21 is input to the gate terminal of the transistor Q21. When a signal at the L level is input to the gate terminal of the transistor Q21, the transistor Q21 sets the non-conductive state between the drain terminal and the source terminal. Thus, the temperature detection circuit 250 outputs the temperature abnormality signal XHOT at the H level. On the other hand, when a signal at the H level is input to the gate terminal of the transistor Q21, the transistor Q21 sets the conductive state between the drain terminal and the source terminal. Thus, the temperature detection circuit 250 outputs the temperature abnormality signal XHOT at the L level. That is, the temperature detection circuit 250 outputs the temperature abnormality signal XHOT at the H level when the diodes D21-1 to D21-k are within the temperature range in which the diodes D21-1 to D21-k can operate stably, and the temperature of the semiconductor device including the diodes D21-1 to D21-k is within the predetermined range, and outputs the temperature abnormality signal XHOT at the L level when the diodes D21-1 to D21-k exceed the temperature range in which the diodes D21-1 to D21-k can operate stably, and the temperature of the semiconductor device including the diodes D21-1 to D21-k exceeds the predetermined range.

Here, as shown in FIG. 11, the wiring lines for the temperature detection circuits 250-1 to 250-n to output the temperature abnormality signal XHOT are coupled in common. When a temperature abnormality occurs in any one of the temperature detection circuits 250-1 to 250-n, the transistor Q21 provided to the temperature detection circuit 250 in which the temperature abnormality has occurred is controlled so as to set the conductive state between the drain terminal and the source terminal. That is, in the temperature detection circuits 250-1 to 250-n, the wiring lines through which the temperature abnormality signal XHOT propagates are coupled to each other in a wired-OR manner. Further, when the temperature abnormality occurs in any one of the temperature detection circuits 250-1 to 250-n, the wiring line output from the temperature abnormality signal XHOT is controlled to the L level, and when the temperature abnormality does not occur in all of the temperature detection circuits 250-1 to 250-n, the wiring line through which the temperature abnormality signal XHOT is output is controlled to the H level.

### 5. Configuration and Operation of Ejection State Determination Circuit

### 5.1 Configuration and Operation of State Determination Circuit

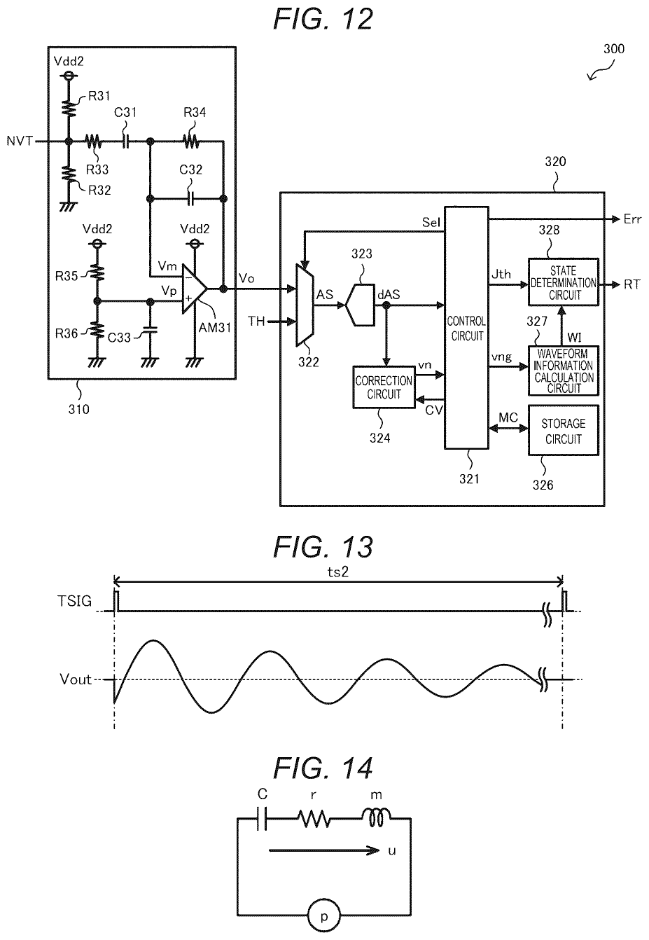

Then, the configuration and the operation of the ejection state determination circuit 300 that determines the state of the corresponding ejection unit 600 based on the residual vibration signal NVT output by the drive signal selection circuit 200 will be described. FIG. 12 is a diagram illustrating an example of the configuration of the ejection state determination circuit 300. As illustrated in FIG. 12, the ejection state determination circuit 300 includes a second waveform shaping circuit 310 and a residual vibration determination circuit 320. Then, the ejection state determination circuit 300 determines the state of the ejection unit 600 based on the residual vibration signal NVT and the temperature information signal TH.

The second waveform shaping circuit 310 includes resistors R31 to R36, capacitors C31 to C33, and an operational amplifier AM31. The residual vibration signal NVT output by the drive signal selection circuit 200 is input to the second waveform shaping circuit 310. Then, the second waveform shaping circuit 310 shapes the signal waveform by extracting a signal of a predetermined frequency component from the residual vibration signal NVT input thereto, and then outputs a voltage signal Vo obtained by amplifying the signal waveform thus shaped. Here, the voltage signal Vo that is output by the second waveform shaping circuit 310 when the residual vibration signal NVT input to the second waveform shaping circuit 310 is the signal based on the residual vibration signal Vout corresponding to the residual vibration generated in the ejection unit 600 as the inspection target is referred to as a residual vibration signal Vnvt. That is, when the residual vibration signal NVT based on the residual vibration signal Vout corresponding to the residual vibration caused by the drive signal COM is input, the second waveform shaping circuit 310 outputs the residual vibration signal Vnvt obtained by shaping the waveform of the residual vibration signal NVT.

A voltage signal Vdd2 having a constant voltage value is supplied to the second waveform shaping circuit 310. The voltage signal Vdd2 may be generated by, for example, a power supply circuit (not shown) disposed outside the second waveform shaping circuit 310. A voltage signal Vdd2 is supplied to one end of the resistor R31. The other end of the resistor R31 is electrically coupled to one end of the resistor R32. The ground potential is supplied to the other end of the resistor R32. Then, the residual vibration signal NVT output by the drive signal selection circuit 200 is input to a connection point at which the other end of the resistor R31 and one end of the resistor R32 are electrically coupled.

One end of the resistor R33 is electrically coupled to the connection point where the other end of the resistor R31 and the one end of the resistor R32 are electrically coupled. The other end of the resistor R33 is electrically coupled to one end of the capacitor C31. The other end of the capacitor C31 is electrically coupled to one end of the resistor R34, one end of the capacitor C32, and a negative input terminal of the operational amplifier AM31. The voltage signal Vdd2 is supplied to one end of the resistor R35. The other end of the resistor R35 is electrically coupled to one end of the resistor R36, one end of the capacitor C33, and a positive input terminal of the operational amplifier AM31. The ground potential is supplied to the other end of the resistor R36 and the other end of the capacitor C32. The other end of the resistor R34 and the other end of the capacitor C32 are electrically coupled to an output terminal of the operational amplifier AM31. That is, the second waveform shaping circuit 310 includes the operational amplifier AM31 including the negative input terminal, the positive input terminal, and the output terminal.

Then, the operational amplifier AM31 is driven based on the voltage signal Vdd2 input to the high-voltage-side power supply terminal and the ground potential input to the low-voltage-side power supply terminal, generates the voltage signal Vo based on the signal input to the negative input terminal and the signal input to the positive input terminal, and outputs the voltage signal Vo from the output terminal. That is, the operational amplifier AM31 includes the low-voltage-side power supply terminal that defines a lower limit of the voltage value of the signal to be output from the output terminal, and the high-voltage-side power supply terminal that defines an upper limit of the voltage value of the signal to be output from the output terminal, wherein the ground potential is input to the low-voltage-side power supply terminal, and the voltage signal Vdd2 that is a positive potential higher in potential than the ground potential is input to the high-voltage-side power supply terminal. Further, the operational amplifier AM31 outputs the voltage signal Vo the voltage value of which varies between the ground potential and the voltage value of the voltage signal Vdd2. Here, in the following description, a signal input to the positive input terminal of the operational amplifier AM31 may be referred to as a voltage signal Vp, and a signal input to the negative input terminal of the operational amplifier AM31 may be referred to as a voltage signal Vm in some cases.

In the second waveform shaping circuit 310 configured as described above, the operational amplifier AM31, the resistors R33, R34, and the capacitor C31 function as an active high-pass filter that extracts a signal of a high frequency component from the residual vibration signal NVT, amplifies the signal of the high frequency component thus extracted, and performs a level shift of the reference potential based on the voltage value of the voltage signal Vp. Further, the operational amplifier AM31, the resistors R33, R34, and the capacitor C32 function as an active low-pass filter that extracts a signal of a low frequency component from the residual vibration signal NVT, then inverts and amplifies the signal of the low frequency component thus extracted, and then performs the level shift of the reference potential based on the voltage value of the voltage signal Vp.

That is, the second waveform shaping circuit 310 has an active band-pass filter that outputs the voltage signal Vo by extracting the signal of a frequency component in a predetermined range from the residual vibration signal NVT input thereto to thereby remove the noise component and shape the signal waveform, and performing the level shift of the reference potential of the signal thus shaped based on the voltage signal Vp input to the positive input terminal of the operational amplifier AM31, and then inverting and amplifying the result.

The residual vibration determination circuit 320 includes a control circuit 321, a multiplexer 322, an AD (Analog-to-Digital) conversion circuit 323, a correction circuit 324, a storage circuit 326, a waveform information calculation circuit 327, and a state determination circuit 328. Then, the residual vibration determination circuit 320 determines the state of the ejection unit 600 based on the residual vibration signal Vnvt that the second waveform shaping circuit 310 outputs as the voltage signal Vo.

The control circuit 321 controls various constituents of the residual vibration determination circuit 320. The storage circuit 326 stores information of a predetermined determination threshold value, correction information, and the like for the residual vibration determination circuit 320 to determine the state of the ejection unit 600 based on the residual vibration signal Vnvt. Further, the storage circuit 326 temporarily holds various signals for the residual vibration determination circuit 320 to determine the state of the ejection unit 600 based on the residual vibration signal Vnvt. The storage circuit 326 described above includes a volatile memory such as a register or a RAM (Random Access Memory), and a nonvolatile memory such as a ROM (Read Only Memory) or a flash memory.

The voltage signal Vo output by the second waveform shaping circuit 310 and the temperature information signal TH output by the temperature detection circuit 250 of the drive signal selection circuit 200 are input to the multiplexer 322. Further, a select signal Sel output by the control circuit 321 is input to a control terminal of the multiplexer 322. The multiplexer 322 selects the voltage signal Vo or the temperature information signal TH based on the select signal Sel input to the control terminal, and outputs the signal thus selected as an acquisition signal AS to the AD conversion circuit 323.

The AD conversion circuit 323 converts the acquisition signal AS input thereto into a digital signal in a predetermined sampling period and then outputs the digital signal as an acquisition signal dAS. That is, the residual vibration determination circuit 320 includes the AD conversion circuit 323 that converts the residual vibration signal Vnvt output as the voltage signal Vo and the temperature information signal TH into the digital signal. Then, the AD conversion circuit 323 outputs the acquisition signal dAS thus generated to the control circuit 321 and the correction circuit 324.

The control circuit 321 acquires the acquisition signal dAS input from the AD conversion circuit 323. Then, the control circuit 321 generates a memory control signal MC for storing the acquisition signal dAS thus acquired in the storage circuit 326, and then outputs the memory control signal MC to the storage circuit 326. Thus, the control circuit 321 stores the acquisition signal dAS thus acquired in the storage circuit 326.

Further, the control circuit 321 generates a memory control signal MC for reading out the correction information stored in the storage circuit 326 and then outputs the memory control signal MC to the storage circuit 326. Thus, the control circuit 321 acquires the correction information. Then, the control circuit 321 generates a correction information signal CV corresponding to the correction information thus acquired and outputs the correction information signal CV to the correction circuit 324.

The acquisition signal dAS output by the AD conversion circuit 323 and the correction information signal CV output by the control circuit 321 are input to the correction circuit 324. The correction circuit 324 corrects the acquisition signal dAS output by the AD conversion circuit 323 based on the correction information signal CV at the timing based on the sampling period of the AD conversion circuit 323. Then the correction circuit 324 outputs the acquisition signal dAS thus corrected to the control circuit 321 as a detection voltage signal vn. Here, the correction at the timing based on the sampling period ideally means correction for each sampling period of the AD conversion circuit 323, but includes correction for a plurality of sampling periods in accordance with a processing load of the residual vibration determination circuit 320. That is, the correction at the timing based on the sampling period includes correction at the timing synchronized with the sampling period of the AD conversion circuit 323.

The control circuit 321 sequentially acquires the detection voltage signal vn input from the correction circuit 324. Then, the control circuit 321 generates a memory control signal MC for storing the detection voltage signal vn thus acquired in the storage circuit 326. Thus, the storage circuit 326 stores a plurality of the detection voltage signals vn sequentially corrected and output by the correction circuit 324 at the timing based on the sampling period of the AD conversion circuit 323.

Further, the control circuit 321 generates the memory control signal MC for reading out the plurality of detection voltage signals vn stored in the storage circuit 326 and then outputs the memory control signal MC to the storage circuit 326. Thus, the control circuit 321 acquires the plurality of detection voltage signals vn. Then, the control circuit 321 generates a detection voltage signal group vng including the plurality of detection voltage signals vn thus acquired, and then outputs the detection voltage signal group vng to the waveform information calculation circuit 327.

The waveform information calculation circuit 327 calculates waveform information such as the amplitude and the frequency of the residual vibration signal Vnvt provided to the voltage signal Vo based on the detection voltage signal group vng thus input. Then, the waveform information calculation circuit 327 generates a waveform information signal WI including the waveform information calculated, and then outputs the waveform information signal WI to the state determination circuit 328.

The control circuit 321 generates the memory control signal MC for reading out the determination threshold value for determining the state of the ejection unit 600 based on the residual vibration signal Vnvt from the storage circuit 326, and outputs the memory control signal MC to the storage circuit 326. Thus, the control circuit 321 acquires the determination threshold value. Then, the control circuit 321 generates the determination threshold signal Jth including the determination threshold value thus acquired, and then outputs the determination threshold signal Jth to the state determination circuit 328.

The state determination circuit 328 determines the state of the ejection unit 600 as the inspection target based on the waveform information signal WI output by the waveform information calculation circuit 327 and the determination threshold signal Jth output by the control circuit 321, and then generates and outputs the determination result signal RT according to the determination result. The determination result signal RT output by the state determination circuit 328 is output from the residual vibration determination circuit 320 and the ejection state determination circuit 300, and is input to the control circuit 100.

Further, when an abnormality occurs in the residual vibration determination circuit 320, the control circuit 321 generates the abnormality information signal Err representing that an abnormality has occurred. The abnormality information signal Err output from the control circuit 321 is output from the residual vibration determination circuit 320 and the ejection state determination circuit 300, and is input to the control circuit 100.

### 5.2. State Determination of Ejection Unit in Determination Circuit

Here, the relationship between the residual vibration generated in the ejection unit 600 and the state of the ejection unit 600 will be described. As described above, the residual vibration signal NVT and the residual vibration signal Vnvt are signals shaped by extracting the AC component of the residual vibration signal Vout based on the residual vibration to remove the noise component, and amplifying the result with a known gain. Therefore, when taking the gain into consideration in determining the state of the ejection unit 600, substantially the same determination results are ideally obtained in the state of the ejection unit 600 determined in accordance with the residual vibration signal Vout and the state of the ejection unit 600 determined based on the residual vibration signals NVT, Vnvt. Therefore, in the following description, the relationship between one example of the residual vibration signal Vout corresponding to the residual vibration generated in the ejection unit 600 and the state of the ejection unit 600 corresponding to the residual vibration signal Vout will be described, and the description of the relationship between the residual vibration signals NVT, Vnvt obtained by shaping the waveform of the residual vibration signal Vout in accordance with the residual vibration and the state of the corresponding ejection unit 600 will be omitted.

When describing the relationship between the residual vibration generated in the ejection unit 600 and the state of the ejection unit 600, first, an example of the residual vibration signal Vout corresponding to the residual vibration will be described. FIG. 13 is a diagram illustrating an example of a signal waveform of the residual vibration signal Vout.

As described using FIGS. 6 to 9, when determining the state of the ejection unit 600 as the inspection target, the control circuit 100 outputs the print data SId [SIH, SIM, SIL]=[1, 1, 1] as the print data SId corresponding to the ejection unit 600 as the inspection target. Thus, the switching circuit 210 supplies the drive signal Vin including the drive waveform Bdp1 to one end of the ejection unit 600 as the inspection target in the period ts1. The piezoelectric element 60 is driven when the drive signal Vin including the drive waveform Bdp1 is supplied to the one end thereof. Due to the drive of the piezoelectric element 60, the vibration plate 621 is displaced, and the internal pressure of the cavity 631 changes according to the displacement of the vibration plate 621. Subsequently, when the drive signal Vin constant at the voltage Vd is supplied to one end of the piezoelectric element 60, an attenuating vibration corresponding to a change in the internal pressure of the cavity 631 occurs in the vibration plate 621. At this moment, the piezoelectric element 60 is displaced due to the attenuating vibration generated in the vibration plate 621. Then, the electromotive force is generated between the electrode 611 and the electrode 612 of the piezoelectric element 60 due to the displacement generated in the piezoelectric element 60. That is, when the piezoelectric element 60 is driven in the period ts1, weak electromotive force corresponding to the attenuating vibration generated in the vibration plate 621 is generated between the electrode 611 and the electrode 612 of the piezoelectric element 60.

In the subsequent period ts2, the transfer gate 234b of the switching circuit 210 is turned off, and the transfer gate 234c is turned on.

As a result, the switching circuit 210 acquires the residual vibration signal Vout corresponding to the attenuating vibration in which the voltage amplitude decreases with time as shown in FIG. 13, and then outputs the residual vibration signal Vout thus acquired to the first waveform shaping circuit 240. Then, in the period ts3, the transfer gate 234b of the switching circuit 210 is turned on, and the transfer gate 234c is turned off, and thus, the drive signal Vin including the drive waveform Bdp3 is supplied to one end of the piezoelectric element 60. Thus, the voltage value at the one end of the ejection unit 600 as the inspection target is controlled from the voltage Vd to the voltage Vc. That is, the displacement of the piezoelectric element 60 is controlled to a steady state.

The residual vibration determination circuit 320 in the present embodiment determines the state of the ejection unit 600 as the inspection target based on the waveform information such as the amplitude and the frequency of the residual vibration signal Vout corresponding to the residual vibration that is the waveform information such as the amplitude and the frequency of the residual vibration signal Vnvt corresponding to the residual vibration signals Vout, NVT corresponding to the residual vibration.

Here, an example of the relationship between the waveform information of the residual vibration signal Vout and the state of the ejection unit 600 as the inspection target will be described. FIG. 14 is a diagram illustrating a calculation model of a simple harmonic motion assuming the residual vibration generated in the ejection unit 600. As described above, when the drive signal Vin is supplied to the piezoelectric element 60, the piezoelectric element 60 is displaced, and in accordance with the displacement of the piezoelectric element 60, the vibration plate 621 is also displaced. Thus, the volume of the cavity 631 contracts after being expanded. On this occasion, a part of the ink filling the cavity 631 is ejected from the nozzle 651 due to pressure generated inside the cavity 631.

During the series of operations of such an ejection unit 600, the vibration plate 621 vibrates freely with a natural vibration frequency determined by a flow path resistance r that depends on the shape of the flow path through which the ink flows, the viscosity of the ink, and so on, an inertance m depending on the liquid weight in the flow path, and a compliance C of the vibration plate 621. The free vibration of the vibration plate 621 is the residual vibration generated in the ejection unit 600.

The calculation model of the residual vibration of the vibration plate 621 shown in FIG. 14 can be expressed by the pressure p, the inertance m, the compliance C, and the flow resistance r. Then, when calculating the step response when applying the pressure p to the circuit shown in FIG. 14 with respect to volume velocity u, Formulas (1) to (3) are obtained.

$$\begin{matrix}Math 1 & \\ u = \frac{p}{ω \cdot m} {e}^{- α \cdot t} \cdot sin ω t & ( 1 )\end{matrix}$$

$$\begin{matrix}Math 2 & \\ ω = \sqrt{\frac{1}{m \cdot {C}_{m}} - {α}^{2}} & ( 2 )\end{matrix}$$

$$\begin{matrix}Math 3 & \\ α = \frac{r}{2 m} & ( 3 )\end{matrix}$$

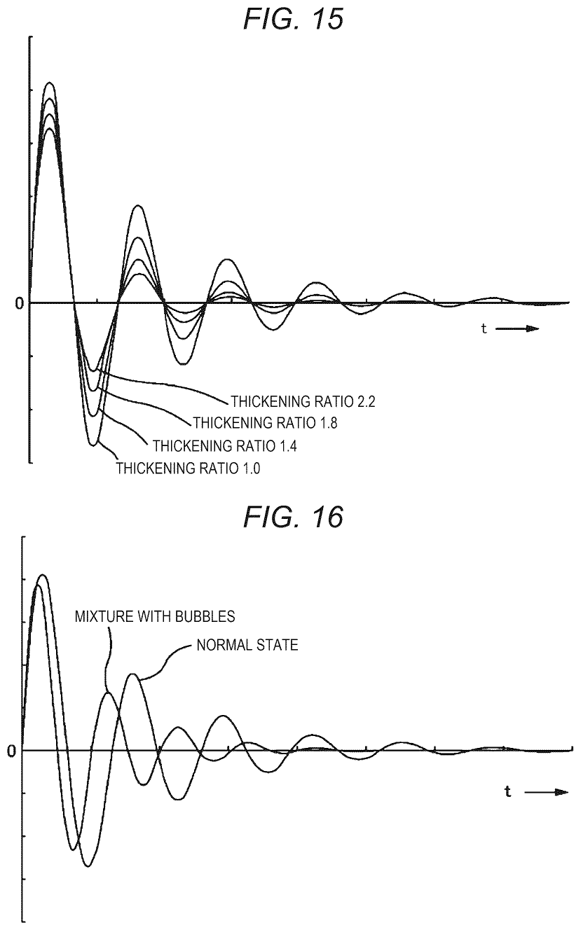

FIG. 15 is a diagram illustrating the relationship between the viscosity of the ink and the signal waveform of the residual vibration. In FIG. 15, the horizontal axis represents time, and the vertical axis represents the magnitude of the residual vibration. When the ink in the vicinity of the nozzle 651 is dried, the viscosity of the ink increases, that is, the ink is thickened. Then, when the ink in the vicinity of the nozzle 651 is thickened, the flow resistance r increases. As a result, as shown in FIG. 15, the attenuation of the residual vibration increases.

Further, FIG. 16 is a diagram illustrating a relationship between mixing of air bubbles and the signal waveform of the residual vibration. In FIG. 16, the horizontal axis represents time, and the vertical axis represents the magnitude of the residual vibration. When air bubbles are mixed in the cavity 631 near the ink flow path or the nozzle 651, the inertance m, which is the liquid weight, is reduced by the amount of the air bubbles mixed therein, in comparison with a normal case. Further, when the inertance m decreases, the angular velocity @ increases as shown in Formula (2). As a result, as shown in FIG. 16, the vibration period of the residual vibration is shortened. That is, the vibration frequency of the residual vibration increases.

As described above, when an abnormality occurs in the ejection unit 600, such as when thickening of the ink occurs in the vicinity of the nozzle 651 of the ejection unit 600 or when the air bubbles are mixed in the cavity 631 of the ejection unit 600, the vibration of the residual vibration generated in the ejection unit 600 changes. Therefore, the waveform information such as the frequency or the amplitude is different between the residual vibration signals Vout, NVT, and Vnvt generated when an abnormality occurs in the ejection unit 600 and the residual vibration signals Vout, NVT, and Vnvt generated when no abnormality occurs in the ejection unit 600.

The residual vibration determination circuit 320 acquires the residual vibration signal Vnvt based on the residual vibration signals Vout, NVT corresponding to the residual vibration which is the attenuating vibration generated in the ejection unit 600 as the inspection target, and then calculates the waveform information such as the amplitude and the frequency of the residual vibration signal Vnvt thus acquired.

Then, the residual vibration determination circuit 320 determines whether the corresponding ejection unit 600 is normal in accordance with the waveform information signal WI including the waveform information. Note that the state of the ejection unit 600 determined by the residual vibration determination circuit 320 is not limited to the thickening of the ink and the mixing of the air bubbles described above, and may be, for example, presence or absence of adhesion of a foreign matter such as a paper piece to the vicinity of the nozzle 651, or presence or absence of ink leakage caused by the adhesion of the foreign matter.

### 5.3 Determination of State of Ejection Unit Based on Residual Vibration

As described above, the residual vibration determination circuit 320 in the present embodiment determines the state of the ejection unit 600 as the inspection target based on the waveform information of the residual vibration signal Vnvt based on the residual vibration signals Vout, NVT corresponding to the residual vibration generated after the ejection unit 600 as the inspection target is driven by the drive signal COM. On that occasion, from the viewpoint of improving the determination accuracy of the state of the ejection unit 600 as the inspection target, improvement of the acquisition accuracy of the waveform information of the residual vibration signal Vnvt in the residual vibration determination circuit 320 is required.

For example, when the residual vibration determination circuit 320 obtains the period and the frequency from the residual vibration signal Vnvt as the waveform information, since the signal waveform of the residual vibration signal Vnvt is the waveform of the attenuating vibration as illustrated in FIG. 13, it is required for the residual vibration determination circuit 320 to accurately figure out the potential to be the reference of the amplitude of the residual vibration signal Vnvt. Further, for example, when the residual vibration determination circuit 320 obtains the amplitude of the residual vibration signal Vnvt as the waveform information, since the residual vibration signal Vnvt is a signal obtained by amplifying the signal waveforms of the residual vibration signals Vout, NVT by the non-inverting amplifier circuit 242 provided to the first waveform shaping circuit 240 and the second waveform shaping circuit 310, it is required for the residual vibration determination circuit 320 to more accurately figure out the gain of the non-inverting amplifier circuit 242 provided to the first waveform shaping circuit 240 and the gain of the second waveform shaping circuit 310.

In the liquid ejection apparatus 1 and the head unit 20 according to the present embodiment, the residual vibration determination circuit 320 determines the state of the ejection unit 600 based on the voltage value of the voltage signal Vo that is output from the output terminal of the operational amplifier AM31 in the state in which the residual vibration signal NVT corresponding to the residual vibration is not input to the negative input terminal of the operational amplifier AM31, and therefore, the voltage signal Vm having a constant potential is input to the negative input terminal of the operational amplifier AM31, and the voltage signal Vp that has a constant potential and is obtained by dividing the voltage signal Vdd2 by the resistance value of the resistor R35 and the resistance value of the resistor R36 is input to the positive input terminal of the operational amplifier AM31, and the residual vibration signal Vnvt as the voltage signal Vo output from the output terminal of the operational amplifier AM31 in the state in which the residual vibration signal NVT corresponding to the residual vibration is input to the negative input terminal of the operational amplifier AM31, and the voltage signal Vp that has a constant potential and is obtained by dividing the voltage signal Vdd2 by the resistance value of the resistor R35 and the resistance value of the resistor R36 is input to the positive input terminal of the operational amplifier AM31. Thus, the residual vibration determination circuit 320 can more accurately acquire the potential to be the reference of the amplitude of the residual vibration signal Vnvt. Accordingly, the residual vibration determination circuit 320 can accurately acquire the period and the frequency of the residual vibration signal Vnvt, and as a result, the determination accuracy of the state of the ejection unit 600 as the inspection target in the residual vibration determination circuit 320 is improved.

Here, in the following description, when the residual vibration signal NVT corresponding to the residual vibration is not input to the negative input terminal of the operational amplifier AM31, the voltage signal Vo output from the output terminal of the operational amplifier AM31 may be referred to as a voltage signal Voff. That is, the second waveform shaping circuit 310 outputs the voltage signal Voff as the voltage signal Vo when the residual vibration signal NVT corresponding to the residual vibration is not input, and outputs the residual vibration signal Vnvt as the voltage signal Vo when the residual vibration signal NVT corresponding to the residual vibration is input.

Further, in the liquid ejection apparatus 1 and the head unit 20 according to the present embodiment, since the non-inverting amplifier circuit 242 provided to the first waveform shaping circuit 240 is configured as the semiconductor device, polysilicon resistors are used as the resistors R11, R12 for defining the gain of the non-inverting amplifier circuit 242. However, the polysilicon resistor significantly changes in resistance value with the temperature, and therefore, the gain of the non-inverting amplifier circuit 242, that is the amplitude rate of the residual vibration signals NVT, Vnvt, significantly depends on the temperature. In contrast, in the liquid ejection apparatus 1 and the head unit 20 according to the present embodiment, the residual vibration determination circuit 320 acquires the residual vibration signal Vnvt and the temperature information signal TH corresponding to the temperature of the first waveform shaping circuit 240, and determines the state of the ejection unit 600 as the inspection target based on the residual vibration signal Vnvt and the temperature information signal TH thus acquired. Therefore, even when the gain of the non-inverting amplifier circuit 242 changes and the voltage value of the amplitude of the residual vibration signal Vnvt changes due to the resistance values of the resistors R11, R12 changing with the temperature, the amplitude of the residual vibration signal Vnvt can appropriately be corrected. Accordingly, the acquisition accuracy of the amplitude of the residual vibration signal Vnvt in the residual vibration determination circuit 320 increases, and as a result, the determination accuracy of the state of the ejection unit 600 as the inspection target in the residual vibration determination circuit 320 is improved.

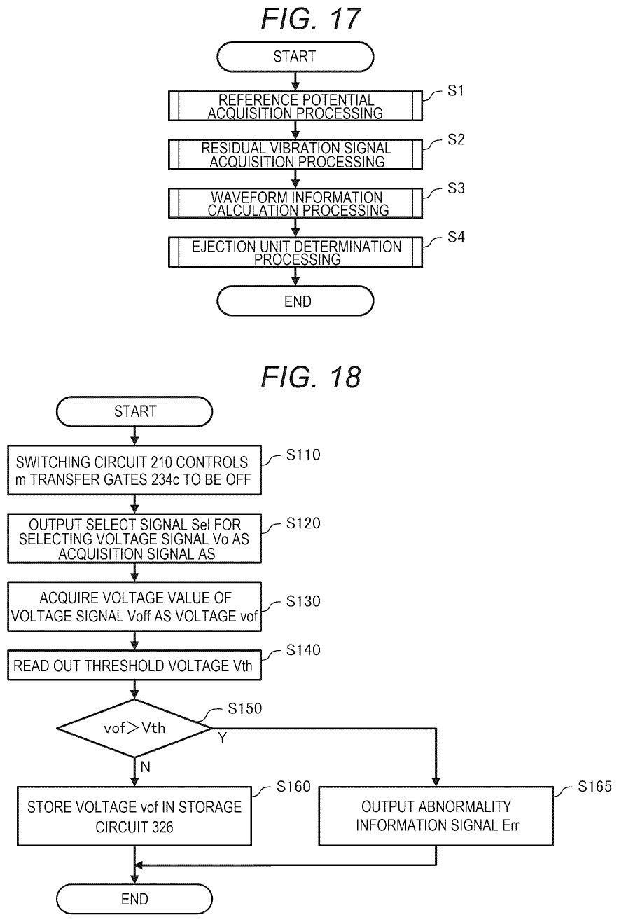

Here, an example of a method of acquiring waveform information of the residual vibration signal Vnvt based on the residual vibration signal Vout, and a method of determining the state of the ejection unit 600 as the inspection target in the liquid ejection apparatus 1 and the head unit 20 according to the present embodiment will be described. FIG. 17 is a diagram illustrating an example of the method of acquiring the waveform information of the residual vibration signal Vnvt and the method of determining the state of the ejection unit 600 as the inspection target.

As shown in FIG. 17, when the waveform information of the residual vibration signal Vnvt is acquired and the state of the ejection unit 600 as the inspection target is determined based on the waveform information thus acquired, the head unit 20 executes (step S1) reference potential acquisition processing of acquiring the voltage value of the voltage signal Voff as the potential of the reference of the amplitude of the residual vibration signal Vnvt, and executes (step S2) residual vibration signal acquisition processing of acquiring the voltage value of the residual vibration signal Vnvt. Subsequently, the head unit 20 executes (step S3) waveform information calculation processing of calculating the waveform information of the residual vibration signal Vnvt based on the voltage value of the voltage signal Voff thus acquired and the voltage value of the residual vibration signal Vnvt, and executes (step S4) ejection unit determination processing of determining the state of the ejection unit 600 based on the waveform information of the residual vibration signal Vnvt thus calculated.

FIG. 18 is a diagram illustrating a specific example of the reference potential acquisition processing. As shown in FIG. 18, in the reference potential acquisition processing, the control circuit 100 outputs the print data signal SI for controlling the m transfer gates 234c provided to the switching circuit 210 of the drive signal selection circuit 200 to be the off state. Thus, the switching circuit 210 controls (step S110) the m transfer gates 234c to be the off state. Therefore, the switching circuit 210 outputs a signal having a constant voltage value as the residual vibration signal Vout.

The residual vibration signal Vout having the constant voltage value output by the switching circuit 210 is blocked by the filter circuit 241 provided to the first waveform shaping circuit 240 and the high-pass filter formed of the second waveform shaping circuit 310. Therefore, the residual vibration signal Vout is not supplied to the negative input terminal of the operational amplifier AM31 provided to the second waveform shaping circuit 310. On that occasion, a signal output from the output terminal of the operational amplifier AM31 is input to the negative input terminal of the operational amplifier AM31 via the resistor R34. That is, by the switching circuit 210 controlling the m transfer gates 234c to be off, the operational amplifier AM31 of the second waveform shaping circuit 310 constitutes a so-called voltage follower circuit in which the voltage signal the same in voltage value as the voltage signal Vm input to the positive input terminal is output from the output terminal. Further, in a period in which the switching circuit 210 controls the m transfer gates 234c to be off, the second waveform shaping circuit 310 outputs the voltage signal Vo output from the operational amplifier AM31 to the residual vibration determination circuit 320 as the voltage signal Voff.

In other words, in the period in which the switching circuit 210 controls the m transfer gates 234c to be off, the voltage signal Vm having the constant voltage value the same as the voltage value of the voltage signal Vo is input to the negative input terminal of the operational amplifier AM31, the voltage signal Vm having the constant voltage value obtained by dividing the voltage signal Vdd2 by the resistor R35 and the resistor R36 is input to the positive input terminal of the operational amplifier AM31, and the operational amplifier AM31 outputs the voltage signal Voff from the output terminal.

After the switching circuit 210 controls the m transfer gates 234c to be off and during the period in which the second waveform shaping circuit 310 outputs the voltage signal Voff as the voltage signal Vo, the control circuit 321 of the residual vibration determination circuit 320 outputs (step S120) the select signal Sel for selecting the voltage signal Vo as an acquisition signal AS. Thus, the multiplexer 322 selects the voltage signal Vo as the acquisition signal AS. The voltage signal Vo selected as the acquisition signal AS by the multiplexer 322 is converted into the acquisition signal dAS which is a digital signal by the AD conversion circuit 323, and is then input to the control circuit 321. That is, the control circuit 321 acquires (step S130) the voltage value of the voltage signal Voff as a voltage vof based on the acquisition signal dAS.

Further, the control circuit 321 reads out (step S140) the threshold voltage Vth for determining whether the voltage vof is normal from the storage circuit 326.

Then, the control circuit 321 determines (step S150) whether the voltage vof is higher than the threshold voltage Vth. When the control circuit 321 determines that the voltage vof is equal to or less than the threshold voltage Vth (N in step S150), the control circuit 321 determines that the voltage signal Voff input thereto is normal, and stores (step S160) the voltage vof thus acquired in the storage circuit 326. In other words, the storage circuit 326 stores the voltage vof which is the voltage value of the voltage signal Voff.

On the other hand, when the control circuit 321 determines that the voltage vof is higher than the threshold voltage Vth (Y in step S150), the control circuit 321 determines that the voltage vof which is the voltage value of the input voltage signal Voff is abnormal, and outputs (step S165) the abnormality information signal Err representing the abnormality of the voltage signal Voff. That is, when the voltage vof which is the voltage value of the voltage signal Voff exceeds the threshold voltage Vth, the residual vibration determination circuit 320 outputs the abnormality information signal Err.

The abnormality information signal Err output by the residual vibration determination circuit 320 is input to the control circuit 100. When the abnormality information signal Err representing the abnormality in the voltage value of the voltage signal Voff is input to the control circuit 100, the control circuit 100 ends the reference potential acquisition processing in the head unit 20. The control circuit 100 may stop the operation of at least one of the liquid ejection apparatus 1 and the head unit 20 at the same time as the termination of the reference potential acquisition processing in the head unit 20.

As described above, the reference potential acquisition processing is a step of executing processing of storing the voltage vof as the voltage value of the voltage signal Voff that is the same in voltage value as the voltage signal Vm, and is output from the output terminal of the operational amplifier AM31 in the state in which the voltage signal Vm having the constant voltage value the same as the voltage value of the voltage signal Vo is input to the negative input terminal of the operational amplifier AM31 and the voltage signal Vm having the constant voltage value obtained by dividing the voltage signal Vdd2 by the resistor R35 and the resistor R36 is input to the positive input terminal of the operational amplifier AM31 in the storage circuit 326.

The reference potential acquisition processing described hereinabove may be performed just once in the manufacturing stage of the liquid ejection apparatus 1, or may be executed every time the residual vibration signal Vout is acquired, but it is preferable for the reference potential acquisition processing to be executed every predetermined period based on the operation time and the temperature of the liquid ejection apparatus 1 and the head unit 20, the number of times of the acquisition of the residual vibration signal Vout, and so on. That is, it is preferable that the voltage vof that is the voltage value of the voltage signal Voff stored in the storage circuit 326 is updated every predetermined period. Accordingly, the residual vibration determination circuit 320 can update the optimum voltage value of the voltage signal Voff in accordance with the operation states of the liquid ejection apparatus 1 and the head unit 20 while reducing the possibility of a significant increase in the processing load of the control circuit 321 associated with the reference potential acquisition processing.

The voltage vof, which is the voltage value of the voltage signal Voff stored in the storage circuit 326, may be updated from the outside of the liquid ejection apparatus 1 via a network line in addition to the reference potential acquisition processing described above. That is, the head unit 20 may include a communication interface circuit (not shown) capable of communicating with the outside of the liquid ejection apparatus 1, and compatible with, for example, Ethernet or communication WiFi communication, and the voltage vof that is the voltage value of the voltage signal Voff stored in the storage circuit 326 may be updated based on the information held in a network server or the like communicably coupled via that communication interface circuit.

As a result, it is possible to reduce the processing load of the control circuit 321 due to the reference potential acquisition processing, and it is also possible to easily and appropriately manage the voltage vof stored in the storage circuit 326 even when the use environment of the liquid ejection apparatus 1 and the head unit 20 is changed, or even when the design change or the maintenance processing is executed in the liquid ejection apparatus 1 and the head unit 20, and thus, it is possible to improve the reliability of the liquid ejection apparatus 1 and the head unit 20.

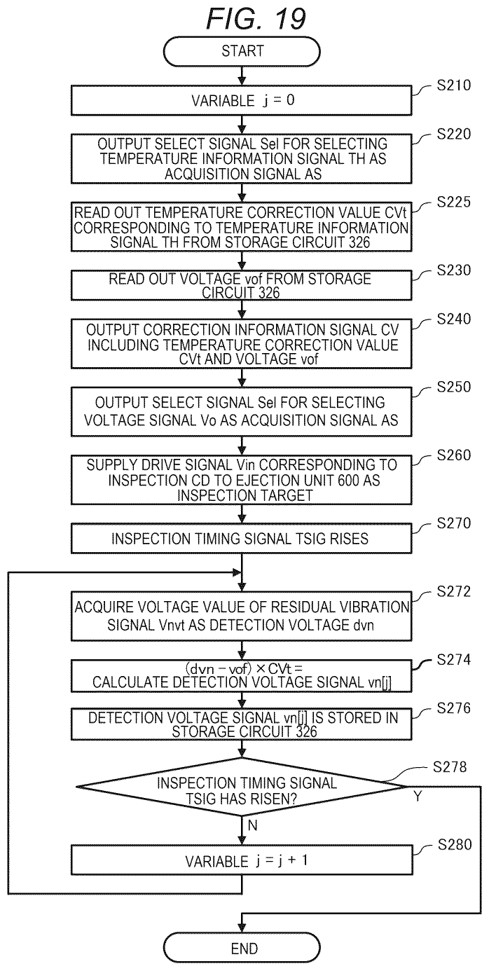

Then, the residual vibration signal acquisition processing will be described. FIG. 19 is a diagram illustrating a specific example of the residual vibration signal acquisition processing. As shown in FIG. 19, in the residual vibration signal acquisition processing, the control circuit 321 of the residual vibration determination circuit 320 sets (step S210) a variable j to “0” as initialization processing.

Subsequently, the control circuit 321 of the residual vibration determination circuit 320 outputs (step S220) the select signal Sel for selecting the temperature information signal TH as an acquisition signal AS. Accordingly, the multiplexer 322 selects the temperature information signal TH as the acquisition signal AS. The temperature information signal TH selected as the acquisition signal AS by the multiplexer 322 is converted into the acquisition signal dAS which is a digital signal by the AD conversion circuit 323, and then input to the control circuit 321. Thus, the control circuit 321 acquires the temperature information signal TH output by the drive signal selection circuit 200. Then, the control circuit 321 generates the memory control signal MC for reading out a temperature correction value CVt corresponding to the temperature information signal TH thus acquired from the storage circuit 326, and then outputs the memory control signal MC to the storage circuit 326. That is, the control circuit 321 reads out (step S225) the temperature correction value CVt corresponding to the temperature information signal TH thus acquired from the storage circuit 326.

Further, the control circuit 321 reads out (step S230) the voltage vof, which is the voltage value of the voltage signal Voff stored in the storage circuit 326 in the reference potential acquisition processing, from the storage circuit 326.

The control circuit 321 generates a correction information signal CV including the temperature correction value CVt and the voltage vof read out from the storage circuit 326. Then, the control circuit 321 outputs (step S240) the correction information signal CV generated and including the temperature correction value CVt and the voltage vof to the correction circuit 324.

Subsequently, the control circuit 321 outputs (step S250) the select signal Sel for selecting the voltage signal Vo as the acquisition signal AS, and the switching circuit 210 supplies (step S260) the drive signal Vin corresponding to the inspection CD to the ejection unit 600 as the inspection target. Here, in step S260, the step of the switching circuit 210 supplying the drive signal Vin corresponding to the inspection CD to the ejection unit 600 as the inspection target corresponds to a step of driving the piezoelectric element 60 to generate the residual vibration in the ejection unit 600 as the inspection target.

Then, when the inspection timing signal TSIG rises (step S270), the residual vibration determination circuit 320 acquires the voltage value of the residual vibration signal Vnvt based on the residual vibration signals Vout, NVT corresponding to the residual vibration generated in the ejection unit 600 as the inspection target.

Specifically, the piezoelectric element 60 provided to the ejection unit 600 as the inspection target is driven by the drive signal Vin corresponding to the inspection CD being supplied to the piezoelectric element 60. Thus, the residual vibration is generated in the ejection unit 600 as the inspection target. The residual vibration signal NVT obtained by shaping the signal waveform of the residual vibration signal Vout corresponding to the residual vibration generated in the ejection unit 600 as the inspection target is input to the negative input terminal of the operational amplifier AM31 of the second waveform shaping circuit 310. On this occasion, the voltage signal Vp having a constant voltage value obtained by dividing the voltage signal Vdd2 by the resistor R35 and the resistor R36 is input to the positive input terminal of the operational amplifier AM31 of the second waveform shaping circuit 310. Therefore, in the output terminal of the operational amplifier AM31 of the second waveform shaping circuit 310, the residual vibration signal Vnvt obtained by extracting a signal of a frequency component in a predetermined range from the residual vibration signal NVT to shape the signal waveform, and then performing the level shift on the reference potential of the signal thus shaped based on the voltage signal Vp to be input to the positive input terminal of the operational amplifier AM31, and then inverting and amplifying the result is output as the voltage signal Vo. In other words, in a state where the residual vibration signal NVT based on the residual vibration signal Vout corresponding to the residual vibration is input to the negative input terminal and the voltage signal Vp having a constant voltage value is input to the positive input terminal, the operational amplifier AM31 outputs the residual vibration signal Vnvt as the voltage signal Vo from the output terminal.

The residual vibration signal Vnvt as the voltage signal Vo output by the operational amplifier AM31 of the second waveform shaping circuit 310 is selected in the multiplexer 322, and is input to the AD conversion circuit 323 as the acquisition signal AS. The AD conversion circuit 323 sequentially converts the voltage value of the residual vibration signal Vnvt as the acquisition signal AS input therein into the digital signal based on the sampling period. Then, the AD conversion circuit 323 outputs a detection voltage dvn of the digital signal corresponding to the voltage value of the residual vibration signal Vnvt as the acquisition signal AS to the correction circuit 324 as the acquisition signal dAS. That is, the correction circuit 324 acquires (step S272) the voltage value of the residual vibration signal Vnvt as the detection voltage dvn.

The correction circuit 324 corrects the detection voltage dvn thus acquired based on the correction information signal CV including the temperature correction value CVt and the voltage vof. Then, the correction circuit 324 outputs the detection voltage signal vn thus acquired to the control circuit 321 as the detection voltage signal vn[j].

Specifically, the correction circuit 324 subtracts the voltage vof from the detection voltage dvn. That is, the correction circuit 324 assumes the voltage vof as the reference potential of the residual vibration signal Vnvt, and calculates the potential difference from the reference potential, that is the voltage value of the residual vibration signal Vnvt when setting the voltage vof as the reference potential. Then, the correction circuit 324 multiplies the electric difference between the voltage vof and the detection voltage dvn thus calculated by the temperature correction value CVt corresponding to the temperature information signal TH. Thus, the variation in the gain of the non-inverting amplifier circuit 242, that is a variation in the resistance values due to the temperature characteristics of the resistors R11, R12 of the non-inverting amplifier circuit 242 is corrected, and the result is output as the detection voltage signal vn[j]. That is, the correction circuit 324 subtracts the voltage vof from the detection voltage dvn, multiplies the value thus obtained by the temperature correction value CVt to thereby calculate (step S274) the detection voltage signal vn[j]. The correction circuit 324 outputs the detection voltage signal vn[j] thus calculated to the control circuit 321.

The control circuit 321 generates the memory control signal MC for storing the detection voltage signal vn[j] input thereto in the storage circuit 326, and then outputs the memory control signal MC to the storage circuit 326. Thus, the detection voltage signal vn[j] is stored (step S276) in the storage circuit 326.

Subsequently, the control circuit 321 determines (step S278) whether the inspection timing signal TSIG has risen. When the control circuit 321 determines that the inspection timing signal TSIG does not rise (N in step S278), the control circuit 321 adds (step S280) 1 to the variable i, and repeats the processing in steps S272, S274, S276, and S278 described above. That is, the AD conversion circuit 323 sequentially acquires the detection voltage dvn, which is the voltage value of the residual vibration signal Vnvt input in a period from when the inspection timing signal TSIG rises to when the inspection timing signal TSIG subsequently rises, and during the period ts2, at the timing based on the sampling period, and the correction circuit 324 sequentially corrects the detection voltage dvn, which is the voltage value of the residual vibration signal Vnvt output by the AD conversion circuit 323 based on the temperature correction value CVt and the voltage vof at the timing based on the sampling period of the AD conversion circuit 323, and sequentially outputs the result as the detection voltage signal vn[j] to the control circuit 321. Then, the control circuit 321 sequentially stores the detection voltage signal vn[j] thus input in the storage circuit 326.

Subsequently, by the control circuit 321 determining that the inspection timing signal TSIG has risen (Y in step S278), the residual vibration signal acquisition processing is terminated on the grounds that the acquisition of the voltage value of the residual vibration signal Vnvt in the period ts2, that is the detection voltage signal vn, is completed.

As described above, in the residual vibration signal acquisition processing, by supplying the drive signal Vin corresponding to the inspection CD to the ejection unit 600 as the inspection target, the residual vibration is generated in the ejection unit 600 as the inspection target. Thus, the residual vibration signal NVT based on the residual vibration signal Vout corresponding to the residual vibration is input to the ejection state determination circuit 300. The residual vibration signal NVT based on the residual vibration signal Vout corresponding to the residual vibration is input to the negative input terminal of the operational amplifier AM31. On this occasion, the voltage signal Vp having a constant potential obtained by dividing the voltage signal Vdd2 by the resistance value of the resistor R35 and the resistance value of the resistor R36 is input to the positive input terminal of the operational amplifier AM31. Then, in the state where the residual vibration signal NVT based on the residual vibration signal Vout corresponding to the residual vibration is input to the negative input terminal, and the voltage signal Vp having a constant potential obtained by dividing the voltage signal Vdd2 by the resistance value of the resistor R35 and the resistance value of the resistor R36 is input to the positive input terminal, the operational amplifier AM31 outputs the residual vibration signal Vnvt based on the residual vibration signal NVT from the output terminal to the residual vibration determination circuit 320.

The residual vibration determination circuit 320 sequentially acquires the voltage value of the residual vibration signal Vnvt input thereto, corrects the voltage value based on the correction information signal CV including the temperature correction value CVt and the voltage vof, and then stores the voltage value thus corrected in the storage circuit 326. Thus, in the residual vibration signal acquisition processing, the voltage value of the residual vibration signal Vnvt setting the voltage vof as the reference potential is acquired.

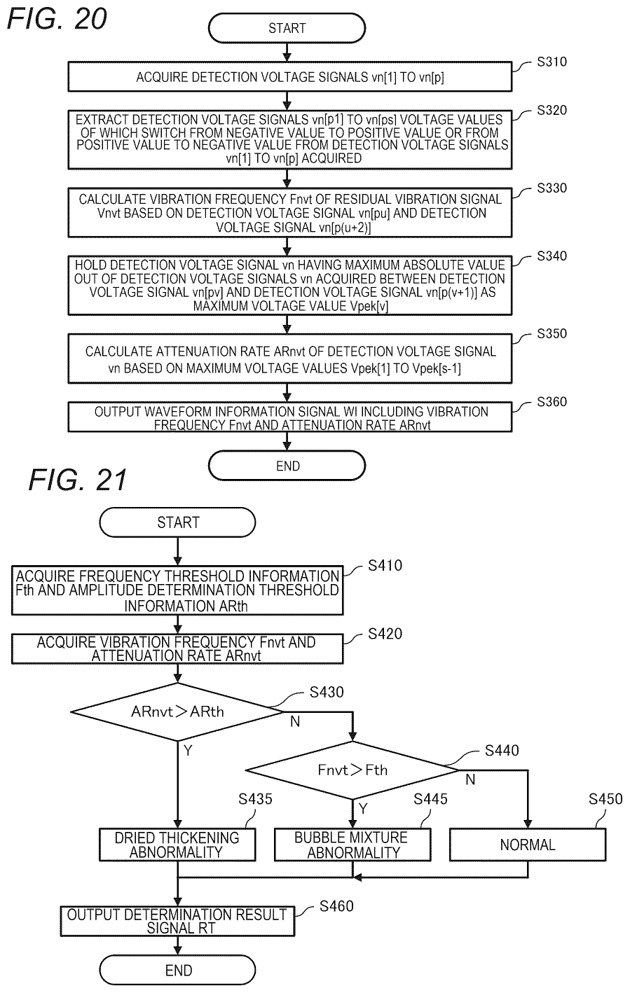

Then, an example of the waveform information calculation processing for calculating the waveform information of the residual vibration signal Vnvt will be described. FIG. 20 is a diagram illustrating a specific example of the waveform information calculation processing. Here, in the following description, the description will be presented assuming that the storage circuit 326 stores p detection voltage signals vn in the period ts2. That is, the description will be presented assuming that the detection voltage signals vn[1] to vn[p] are stored in the storage circuit 326 as the detection voltage signals vn.

When the waveform information calculation processing is started, the control circuit 321 generates the memory control signal MC for reading out the detection voltage signals vn[1] to vn[p] from the storage circuit 326 and then outputs the memory control signal MC to the storage circuit 326. Thus, the control circuit 321 reads out the detection voltage signals vn[1] to vn[p] from the storage circuit 326. Then, the control circuit 321 generates the detection voltage signal group vng including the detection voltage signals vn[1] to vn[p] thus read out, and then outputs the detection voltage signal group vng thus generated to the waveform information calculation circuit 327. Thus, the waveform information calculation circuit 327 obtains (step S310) the detection voltage signals vn[1] to vn[p].

The waveform information calculation circuit 327 extracts, from the detection voltage signals vn[1] to vn[p] thus acquired, the detection voltage signal vn at a timing at which the voltage value switches from a positive value to a negative value or from a negative value to a positive value. Here, in the following description, the detection voltage signal vn at the timing at which the voltage value is changed from a positive value to a negative value or from a negative value to a positive value after the inspection timing signal TSIG rises is referred to as a detection voltage signal vn[p1], and the detection voltage signal vn at a timing at which the voltage value is changed from a positive value to a negative value or from a negative value to a positive value for the last time after the inspection timing signal TSIG rises is referred to as a detection voltage signal vn[ps]. That is, the waveform information calculation circuit 327 extracts (step S320) the detection voltage signals vn[p1] to vn[ps] at the timing when the voltage value switches from a positive value to a negative value or from a negative value to a positive value from the detection voltage signals vn[1] to vn[p] thus acquired.

The waveform information calculation circuit 327 calculates (step S330) a vibration frequency Fnvt of the residual vibration signal Vnvt based on the detection voltage signal vn[pu] (u is any one of 1 to s−2) and the detection voltage signal vn[p(u+2)] out of the detection voltage signals vn[p1] to vn[ps] thus extracted.

Specifically, the waveform information calculation circuit 327 calculates the number of detection voltage signals vn acquired by the control circuit 321 between the detection voltage signal vn[pu] and the detection voltage signal vn[p(u+2)]. Then, the waveform information calculation circuit 327 calculates a time period from the detection voltage signal vn[pu] to the detection voltage signal vn[p(u+2)] from the number of the detection voltage signals vn calculated and the period for the correction circuit 324 to calculate the detection voltage signal vn from the detection voltage dvn that is the period based on the sampling period of the AD conversion circuit 323. Then, the waveform information calculation circuit 327 calculates the vibration frequency Fnvt of the residual vibration signal Vnvt based on the time period from the detection voltage signal vn[pu] to the detection voltage signal vn[p(u+2)] thus calculated, and acquires the vibration frequency Fnvt as the waveform information.

Here, as represented in step S274, the detection voltage signal vn is calculated by subtracting the voltage vof, which is the voltage value of the voltage signal Voff, from the voltage value of the residual vibration signal Vnvt. That is, the timing at which the voltage values of the detection voltage signals vn[1] to vn[p] change from a positive value to a negative value or from a negative value to a positive value corresponds to a timing at which the voltage value of the residual vibration signal Vnvt crosses the voltage value of the voltage signal Voff. That is, the waveform information calculation circuit 327 provided to the residual vibration determination circuit 320 calculates the vibration frequency Fnvt of the residual vibration signal Vnvt as the waveform information based on the voltage vof which is the voltage value of the voltage signal Voff in steps S320, S330.

On this occasion, it is preferable for the waveform information calculation circuit 327 to calculate the vibration frequency Fnvt of the residual vibration signal Vnvt based on the detection voltage signal vn acquired in the vicinity of the rise of the inspection timing signal TSIG defining a start of the inspection. As described above, since the residual vibration signal Vnvt corresponding to the residual vibration is the attenuating vibration, the voltage value of the residual vibration signal Vnvt converges on the reference potential of the residual vibration signal Vnvt with lapse of time. When the waveform information calculation circuit 327 calculates the vibration frequency Fnvt of the residual vibration signal Vnvt, by using the detection voltage signal vn acquired in the vicinity of the rising edge of the inspection timing signal TSIG, it is possible to detect the transition point at which the voltage value of the residual vibration signal Vnvt switches from a positive value to a negative value, or from a negative value to a positive value in a stage in which the residual vibration signal Vnvt has a sufficient amplitude. Thus, the detection accuracy of the transition point increases, and as a result, the calculation accuracy of the vibration frequency Fnvt of the residual vibration signal Vnvt is improved.

Further, the waveform information calculation circuit 327 holds (step S340) the detection voltage signal vn having the maximum absolute value among the detection voltage signals vn obtained between the detection voltage signal vn[pv] (v is any one of 1 to s−1) and the detection voltage signal vn[p(v+1)] as the maximum voltage value Vpek[v]. Specifically, the waveform information calculation circuit 327 holds the detection voltage signal vn having the maximum absolute value out of the detection voltage signals vn acquired between the detection voltage signal vn[p1] and the detection voltage signal vn[p2] as the maximum voltage value Vpek[1], holds the detection voltage signal vn having the maximum absolute value out of the detection voltage signals vn acquired between the detection voltage signal vn[pv] and the detection voltage signal vn[p(v+1)] as the maximum voltage value Vpek[v], and holds the detection voltage signal vn having the maximum absolute value out of the detection voltage signals vn acquired between the detection voltage signal vn[p(s−1)] and the detection voltage signal vn[ps] as the maximum voltage value Vpek[s−1]. The maximum voltage value Vpek[v] held by the waveform information calculation circuit 327 corresponds to the amplitude when the residual vibration signal Vnvt is generated. Then, the waveform information calculation circuit 327 calculates (step S350) the attenuation rate ARnvt of the amplitude of the residual vibration signal Vnvt based on the maximum voltage values Vpek[1] to Vpek[s−1] corresponding to the amplitude when the residual vibration signal Vnvt is generated.

Then, the waveform information calculation circuit 327 generates a waveform information signal WI including the vibration frequency Fnvt and the attenuation rate ARnvt of the amplitude thus calculated, and then outputs (step S360) the waveform information signal WI to the state determination circuit 328.

Then, an example of the ejection unit determination processing will be described. FIG. 21 is a diagram illustrating a specific example of the ejection unit determination processing. As shown in FIG. 21, when the ejection unit determination processing is started, the control circuit 321 generates the memory control signal MC for reading out frequency threshold information Fth and amplitude determination threshold information ARth from the storage circuit 326, and then outputs the memory control signal MC to the storage circuit 326. Thus, the control circuit 321 reads out the frequency threshold information Fth and the amplitude determination threshold information ARth from the storage circuit 326. Then, the control circuit 321 generates a determination threshold signal Jth including the frequency threshold information Fth and the amplitude determination threshold information ARth, and then outputs the determination threshold signal Jth to the state determination circuit 328. That is, the state determination circuit 328 acquires (step S410) the frequency threshold information Fth and the amplitude determination threshold information ARth. Further, the waveform information signal WI that includes the vibration frequency Fnvt and the attenuation rate ARnvt of the amplitude, and that is output by the waveform information calculation circuit 327 is input to the state determination circuit 328. That is, the state determination circuit 328 acquires (step S420) the vibration frequency Fnvt of the residual vibration signal Vnvt and the attenuation rate ARnvt of the amplitude.

Then, the state determination circuit 328 compares the frequency threshold information Fth and the amplitude determination threshold information ARth thus acquired with the vibration frequency Fnvt and the attenuation rate ARnvt of the amplitude to thereby determine as the state of the ejection unit 600 whether a dried thickening abnormality has occurred in the ejection unit 600 as the inspection target, and whether a bubble mixture abnormality has occurred in the ejection unit 600 as the inspection target.

Specifically, the state determination circuit 328 determines (step S430) whether the attenuation rate ARnvt of the amplitude of the residual vibration signal Vnvt is greater than the amplitude determination threshold information ARth. As described above, when the viscosity of the ink increases, the attenuation of the residual vibration signal Vnvt increases. When the attenuation rate ARnvt of the amplitude of the residual vibration signal Vnvt is greater than the amplitude determination threshold information ARth (Y in step S430), the state determination circuit 328 determines that the viscosity of the ink has increased beyond the normal range, and determines (step S435) that the dried thickening abnormality has occurred in the ejection unit 600 as the inspection target. Then, the state determination circuit 328 generates and outputs (step S460) the determination result signal RT representing that the dried thickening abnormality has occurred in the ejection unit 600 as the inspection target.

Further, when the attenuation rate ARnvt of the amplitude of the residual vibration signal Vnvt is equal to or lower than the amplitude determination threshold information ARth (Y in step S430), the state determination circuit 328 determines (step S440) whether the vibration frequency Fnvt of the residual vibration signal Vnvt is greater than the frequency threshold information Fth. As described above, when bubbles are mixed in the cavity 631 of the ejection unit 600, the frequency of the residual vibration signal Vnvt rises. When the vibration frequency Fnvt of the residual vibration signal Vnvt is higher than the frequency threshold information Fth (Y in step S440), the state determination circuit 328 determines that bubbles are mixed in the cavity 631, and determines (step S445) that the bubble mixture abnormality has occurred in the ejection unit 600 as the inspection target. Then, the state determination circuit 328 generates and outputs (step S460) the determination result signal RT representing that the bubble mixture abnormality has occurred in the ejection unit 600 as the inspection target.

Further, when the attenuation rate ARnvt of the amplitude of the residual vibration signal Vnvt is equal to or lower than the amplitude determination threshold information ARth and the vibration frequency Fnvt of the residual vibration signal Vnvt is equal to or lower than the frequency threshold information Fth (N in step S440), the control circuit 321 determines that the ejection unit 600 as the inspection target is normal. Then, the state determination circuit 328 generates and outputs (step S460) the determination result signal RT representing that the ejection unit 600 as the inspection target is normal.

As described above, the residual vibration determination circuit 320 of the present embodiment calculates the waveform information of the residual vibration signal Vnvt based on the residual vibration signal Vnvt converted into the digital signal, the voltage vof which is the voltage value of the voltage signal Voff converted into the digital signal, and the temperature information signal TH converted into the digital signal, and determines the state of the ejection unit 600 as the inspection target based on the waveform information thus calculated.

Here, the ejection unit determination processing corresponds to processing of determining the state of the ejection unit 600 as the inspection target based on the residual vibration signal Vnvt output from the output terminal in a state where the residual vibration signal NVT based on the residual vibration signal Vout corresponding to the residual vibration is input to the negative input terminal of the operational amplifier AM31, and the voltage value Vm having a constant voltage value obtained by dividing the voltage signal Vdd2 by the resistor R35 and the resistor R36 is input to the positive input terminal, and the voltage vof which is the voltage value of the voltage signal Voff that is output from the output terminal and is the same in voltage value as the voltage signal Vm in a state where the voltage signal Vm having a constant voltage value the same as the voltage value of the voltage signal Vo is input to the negative input terminal of the operational amplifier AM31, and the voltage signal Vm having a constant voltage value obtained by dividing the voltage signal Vdd2 by the resistor R35 and the resistor R36 is input to the positive input terminal.

The first waveform shaping circuit 240 and the second waveform shaping circuit 310 are examples of a waveform shaping circuit, the residual vibration determination circuit 320 is an example of a determination circuit, the operational amplifier AM10 is an example of an amplifier circuit, the circuit including the resistor R11 and the resistor R12 is an example of a gain setting circuit, and the AD conversion circuit 323 is an example of an analog-to-digital converter.

Further, the residual vibration signal Vout is an example of a first residual vibration signal, and the residual vibration signal Vnvt that is obtained by shaping the signal waveform of the residual vibration signal Vout by the first waveform shaping circuit 240 and the second waveform shaping circuit 310 is an example of a second residual vibration signal. The drive signal COM including the drive signal ComA and the drive signal ComB is an example of a drive signal. Here, in view of the fact that the drive signal Vin is generated by selecting or deselecting the signal waveforms of the drive signal ComA and the drive signal ComB, the drive signal Vin is also an example of the drive signal.

### 6. Functions and Advantages

As described above, in the liquid ejection apparatus 1 and the head unit 20 according to the present embodiment, the operational amplifier AM31 of the second waveform shaping circuit 310 outputs the voltage signal Voff having the voltage value of the voltage vof from the output terminal in the state in which the voltage signal Vm having the constant voltage value is input to the negative input terminal and the voltage signal Vp having the constant voltage value is input to the positive input terminal. In addition, the operational amplifier AM31 of the second waveform shaping circuit 310 outputs the residual vibration signal Vnvt obtained by amplifying the amplitude of the residual vibration signal NVT corresponding to the residual vibration as the voltage signal Vo from the output terminal taking the voltage signal Vp as the reference potential in the state in which the residual vibration signal NVT corresponding to the residual vibration is input to the negative input terminal as the voltage signal Vm and the voltage signal Vp having a constant voltage value is input to the positive input terminal. Then, the residual vibration determination circuit 320 stores the voltage vof, which is the voltage value of the voltage signal Voff output by the operational amplifier AM31 of the second waveform shaping circuit 310, in the storage circuit 326, and determines the state of the ejection unit 600 as the inspection target based on the residual vibration signal Vnvt output by the operational amplifier AM31 of the second waveform shaping circuit 310 and the voltage vof which is the voltage value of the voltage signal Voff stored in the storage circuit 326.

That is, the residual vibration determination circuit 320 determines the state of the ejection unit 600 based on the residual vibration signal Vnvt that vibrates taking the voltage signal Vp as the reference potential and the voltage vof that is the voltage value of the voltage signal Voff corresponding to the voltage signal Vp stored in advance. Thus, the residual vibration determination circuit 320 accurately figures out the reference potential of the residual vibration signal Vnvt, and determines the state of the ejection unit 600 as the inspection target. As a result, the determination accuracy of the state of the ejection unit 600 as the inspection target in the residual vibration determination circuit 320 is improved.

Specifically, the residual vibration determination circuit 320 calculates the vibration frequency Fnvt, which is one of the waveform information of the residual vibration signal Vnvt that vibrates taking the voltage signal Vp as the reference potential, based on the reference potential of the residual vibration signal Vnvt calculated based on the voltage vof that is the voltage value of the voltage signal Voff corresponding to the voltage signal Vp stored in advance. Thus, it becomes possible for the residual vibration determination circuit 320 to accurately calculate the vibration frequency Fnvt of the residual vibration signal Vnvt, and the determination accuracy of the state of the ejection unit 600 as the inspection target based on the vibration frequency Fnvt thus calculated is improved.

Further, in the liquid ejection apparatus 1 and the head unit 20 according to the present embodiment, the voltage signal Vo output by the operational amplifier AM31 of the second waveform shaping circuit 310 is input to the negative input terminal of the operational amplifier AM31 as the voltage signal Vm having a constant voltage value in a period in which the residual vibration signal NVT corresponding to the residual vibration is not input to the negative input terminal. That is, the operational amplifier AM31 of the second waveform shaping circuit 310 operates as a voltage follower circuit. On this occasion, the operational amplifier AM31 outputs the voltage signal Voff the same in voltage value as the voltage signal Vp from the output terminal as the voltage signal Vo. Thus, when the residual vibration determination circuit 320 calculates the vibration frequency Fnvt that is one of the waveform information of the residual vibration signal Vnvt, the voltage vof that is the voltage value of the voltage signal Voff stored in advance can directly be used as the reference potential of the residual vibration signal Vnvt. Accordingly, it is possible to accurately calculate the vibration frequency Fnvt of the residual vibration signal Vnvt while reducing the calculation load of the vibration frequency Fnvt of the residual vibration signal Vnvt in the residual vibration determination circuit 320.

Further, in the liquid ejection apparatus 1 and the head unit 20 according to the present embodiment, the first waveform shaping circuit 240 and the second waveform shaping circuit 310 to which the residual vibration signal Vout corresponding to the residual vibration generated by the drive signal COM is input, and which output the residual vibration signal Vnvt obtained by shaping the waveform of the residual vibration signal Vout are provided, and even when the first waveform shaping circuit 240 includes the operational amplifier AM10 that is configured as a single semiconductor device, and amplifies the residual vibration signal Vout, and the resistors R11, R12 for setting the gain of the operational amplifier AM10, the residual vibration determination circuit 320 determines the state of the ejection unit 600 as the inspection target based on the residual vibration signal Vnvt and the temperature information signal TH corresponding to the temperature of the first waveform shaping circuit 240, and thus, it is possible for the residual vibration determination circuit 320 to accurately correct the resistance values of the resistors R11, R12 large in change in resistance value with the temperature, namely the gain of the amplitude of the residual vibration signal Vout in the first waveform shaping circuit 240. Thus, the residual vibration determination circuit 320 can accurately calculate the attenuation rate ARnvt of the amplitude of the residual vibration signal Vnvt, which is the waveform information of the amplitude of the residual vibration signal Vnvt. As a result, the determination accuracy of the state of the ejection unit 600 as the inspection target in the residual vibration determination circuit 320 is improved.

In addition, in the liquid ejection apparatus 1 and the head unit 20 according to the present embodiment, the residual vibration determination circuit 320 includes the AD conversion circuit 323, converts the residual vibration signal Vnvt, the voltage signal Voff, and the temperature information signal TH input thereto into the digital signals, then corrects the digital signals, and calculates the waveform information of the residual vibration signal Vnvt. Thus, the residual vibration determination circuit 320 can directly acquire the voltage value of the residual vibration signal Vnvt input thereto. As a result, the calculation accuracy of the waveform information of the residual vibration signal Vnvt in the residual vibration determination circuit 320 and the determination accuracy of the state of the ejection unit 600 as the inspection target are improved.

On this occasion, the residual vibration determination circuit 320 selects the residual vibration signal Vnvt, the voltage signal Voff, and the temperature information signal TH with the multiplexer 322, and converts each of the residual vibration signal Vnvt, the voltage signal Voff, and the temperature information signal TH into a digital signal with the AD conversion circuit 323 common thereto. As a result, the possibility that the circuit scale of the residual vibration determination circuit 320 increases is reduced to make it possible to reduce the size of the head unit 20, and the possibility that an error occurs in the digital value due to the variation of the AD conversion circuit 323 is reduced. Accordingly, the calculation accuracy of the waveform information of the residual vibration signal Vnvt in the residual vibration determination circuit 320 and the determination accuracy of the state of the ejection unit 600 as the inspection target are improved.

### 7. Modified Examples

In the liquid ejection apparatus 1 and the head unit 20 according to the present embodiment described above, the residual vibration determination circuit 320 determines the state of the ejection unit 600 based on the voltage vof that is the voltage value of the voltage signal Voff as the voltage signal Vo output from the output terminal of the operational amplifier AM31 in the state in which the voltage signal Vm having the constant voltage value is input to the negative input terminal of the operational amplifier AM31, and the voltage signal Vp having the constant voltage value is input to the positive input terminal of the operational amplifier AM31, and the residual vibration signal Vnvt as the voltage signal Vo output from the output terminal of the operational amplifier AM31 in the state where the residual vibration signal NVT corresponding to the residual vibration is input to the negative input terminal of the operational amplifier AM31 and the voltage signal Vp having the constant voltage value is input to the positive input terminal of the operational amplifier AM31. On this occasion, since the residual vibration determination circuit 320 can accurately calculate the reference potential of the amplitude of the residual vibration signal Vnvt based on the voltage vof, the calculation accuracy of vibration frequency Fnvt of the residual vibration signal Vnvt is improved, and as a result, the determination accuracy of the state of the ejection unit 600 as the inspection target is improved. That is, it is sufficient for the residual vibration determination circuit 320 to be able to accurately acquire the reference potential of the residual vibration signal Vnvt.

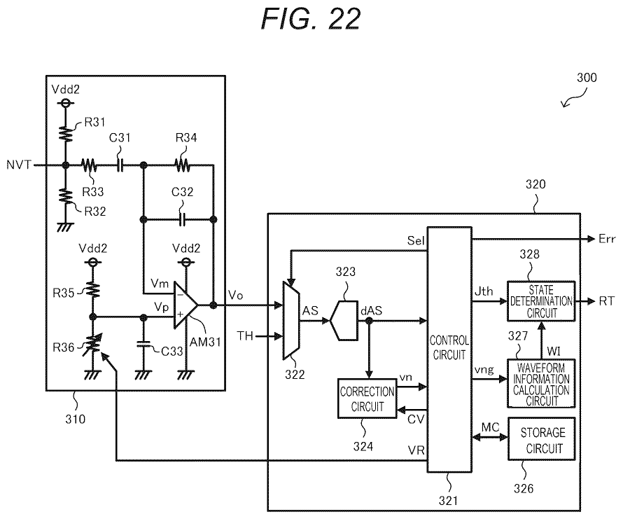

FIG. 22 is a diagram illustrating an example of a configuration of the ejection state determination circuit 300 in a modified example. As shown in FIG. 22, in the ejection state determination circuit 300 of the modified example, the resistor R36 is formed of a variable resistance element capable of adjusting the resistance value, and the storage circuit 326 stores an assumed reference voltage Var calculated from the voltage value of the voltage signal Vdd2 and the resistance values of the resistors R35, R36. Further, the control circuit 321 outputs a resistance value adjustment signal VR for adjusting the resistance value of the resistor R36 so that the voltage value of the voltage signal Vo output from the output terminal of the operational amplifier AM31 approximates to the assumed reference voltage Var stored in the storage circuit 326 in a state in which the residual vibration signal NVT corresponding to the residual vibration is not input to the negative input terminal of the operational amplifier AM31, and accordingly the voltage signal Vm having a constant potential is input to the negative input terminal of the operational amplifier AM31, and the voltage signal Vp having a constant potential obtained by dividing the voltage signal Vdd2 by the resistance value of the resistor R35 and the resistance value of the resistor R36 is input to the positive input terminal of the operational amplifier AM31. Then, the control circuit 321 stores, in the storage circuit 326, an adjustment value of the resistance value of the resistor R36 when the voltage value of the voltage signal Vo output from the output terminal of the operational amplifier AM31 becomes substantially equal to the voltage value of the assumed reference voltage Var stored in the storage circuit 326.

Then, after adjusting the resistance value of the resistor R36 based on the adjustment value of the resistance value stored in the storage circuit 326, the residual vibration determination circuit 320 acquires the residual vibration signal Vnvt as the voltage signal Vo output from the output terminal of the operational amplifier AM31 in the state in which the residual vibration signal NVT corresponding to the residual vibration is input to the negative input terminal of the operational amplifier AM31, and the voltage signal Vp having a constant potential obtained by dividing the voltage signal Vdd2 by the resistance value of the resistor R35 and the resistance value of the resistor R36 is input to the positive input terminal of the operational amplifier AM31, calculates the vibration frequency Fnvt of the residual vibration signal Vnvt based on the residual vibration signal Vnvt thus acquired and the assumed reference voltage Var, and then determines the state of the ejection unit 600 as the inspection target based on the vibration frequency Fnvt thus calculated.

Even in this case, substantially the same functions and advantages as those of the embodiment described above are exerted. Note that the resistor R35 may be formed of a variable resistance element capable of adjusting the resistance value instead of or in addition to the resistor R36.

That is, in the liquid ejection apparatus 1 and the head unit 20 according to the modified example, the storage circuit 326 stores the assumed reference voltage Var that is the assumed reference potential of the residual vibration signal Vnvt, the second waveform shaping circuit 310 includes the resistor R35, one end of which is input with the voltage signal Vdd2, and the other end of which is electrically coupled to the positive input terminal of the operational amplifier AM31, and the resistor R36, one end of which is electrically coupled to the positive input terminal of the operational amplifier AM31, and the other end of which is input with the ground potential, at least one of the resistor R35 and the resistor R36 includes the variable resistance element, the residual vibration determination circuit 320 may adjust the resistance value of the resistor R36 so that the voltage value of the voltage signal Vo output from the output terminal of the operational amplifier AM31 approximates to the assumed reference voltage Var stored in the storage circuit 326 in the state in which the residual vibration signal NVT corresponding to the residual vibration is not input to the negative input terminal of the operational amplifier AM31, and accordingly, the voltage signal Vm having the constant potential is input to the negative input terminal of the operational amplifier AM31, and the voltage signal Vp having the constant potential obtained by dividing the voltage signal Vdd2 by the resistance value of the resistor R35 and the resistance value of the resistor R36 is input to the positive input terminal of the operational amplifier AM31, may calculate the vibration frequency Fnvt as the waveform information of the residual vibration signal NVT based on the residual vibration signal Vnvt as the voltage signal Vo output from the output terminal of the operational amplifier AM31 and the assumed reference voltage Var in the state in which the residual vibration signal NVT corresponding to the residual vibration is input to the negative input terminal of the operational amplifier AM31, and the voltage signal Vp having the constant potential obtained by dividing the voltage signal Vpp2 by the resistance value of the resistor R35 and the resistance value R36 thus adjusted is input to the positive input terminal of the operational amplifier AM31, and may determine the state of the ejection unit 600 as the inspection target based on the vibration frequency Fnvt thus calculated.

Further, in the liquid ejection apparatus 1 and the head unit 20 described above, there is provided the description assuming that the temperature detection circuit 250 that detects the temperature of the first waveform shaping circuit 240 is provided to the single semiconductor device constituting the drive signal selection circuit 200 together with the first waveform shaping circuit 240, but a part of can the temperature detection circuit 250 sufficiently detect the temperature of the first waveform shaping circuit 240, and may be configured separately from the single semiconductor device that configures the drive signal selection circuit 200. On that occasion, the temperature detection circuit 250 may be a printed circuit board to which the other end of the flexible wiring board 24 one end of which is electrically coupled to the print head 22 is coupled, and may be provided to the head wiring board 23. That is, the head unit 20 may include the print head 22 including the ejection units 600, the flexible wiring board 24 having one end electrically coupled to the print head 22, and the head wiring board 23 electrically coupled to the other end of the flexible wiring board 24, and the single semiconductor device that configures the drive signal selection circuit 200 may be provided to the flexible wiring board 24, and at least a part of the temperature detection circuit 250 may be provided to the head wiring board 23.

Even in this case, since the temperature detection circuit 250 is located in the vicinity of the single semiconductor device that configures the drive signal selection circuit 200 including the first waveform shaping circuit 240, substantially the same functions and advantages as those of the embodiment described above are exerted.

On this occasion, the head wiring board is an example of a wiring board.

Although the embodiments and the modified examples are described above, the present disclosure is not limited to the embodiments and can be implemented in various aspects without departing from the gist thereof. For example, the above described embodiments can be appropriately combined.

The present disclosure includes substantially the same configurations as the configurations described in the embodiments, for example, configurations having the same functions, methods, and results and configurations having the same purposes and effects. Further, the present disclosure includes configurations in which non-essential portions of the configurations described in the embodiments are replaced. Furthermore, the present disclosure includes configurations that may exert the same functions and effects or configurations that may achieve the same purposes as those of the configurations described in the embodiments. In addition, the present disclosure includes configurations obtained by addition of known techniques to the configurations described in the embodiments.

The following configurations are derived from the above described embodiment.

An aspect of a head unit includes:
an ejection unit that includes a piezoelectric element driven by a drive signal and that is configured to eject a liquid in accordance with drive of the piezoelectric element;
a waveform shaping circuit to which a first residual vibration signal corresponding to a residual vibration caused by the drive signal is input, and which is configured to output a second residual vibration signal obtained by shaping a waveform of the first residual vibration signal;
a temperature detection circuit configured to output a temperature information signal corresponding to a temperature of the waveform shaping circuit; and
a determination circuit configured to determine a state of the ejection unit, wherein
the waveform shaping circuit includes an amplifier circuit configured to amplify the first residual vibration signal and a gain setting circuit configured to set a gain of the amplifier circuit, and is configured to output the second residual vibration signal based on a signal amplified by the amplifier circuit,
the amplifier circuit and the gain setting circuit are configured as a single semiconductor device, and
the determination circuit is configured to determine the state of the ejection unit based on the second residual vibration signal and the temperature information signal.

According to this head unit, since the amplifier circuit and the gain setting circuit are configured as the single semiconductor device, an influence of noise can be reduced due to the detection of the first residual vibration on the one hand, a possibility that the gain of the amplifier circuit changes due to an influence of the temperature increases, and as a result, there arises a possibility that the detection accuracy of the amplitude of the second residual vibration signal decreases on the other hand. In contrast, according to this head unit, by the determination circuit determining the state of the ejection unit based on the second residual vibration signal and the temperature information signal corresponding to the temperature of the waveform shaping circuit, it is possible to appropriately correct a change in gain of the amplifier circuit due to the influence of the temperature. As a result, the determination accuracy of the state of the ejection unit in the determination circuit is improved.

In one aspect of the head unit described above, at least a part of the temperature detection circuit may be provided to the semiconductor device.

According this to head unit, since the temperature detection circuit is formed of the same semiconductor device as that of the amplifier circuit and the gain setting circuit, the reduction in size of the head unit can be realized.

In one aspect of the head unit described above, there may further be included:
a print head including the ejection unit;
a flexible wiring board having one end electrically coupled to the print head; and
a wiring board to which another end of the flexible wiring board is electrically coupled, wherein
the semiconductor device may be provided to the flexible wiring board, and
at least a part of the temperature detection circuit may be provided to the wiring board.

In one aspect of the head unit described above,
the determination circuit may include an analog-to-digital converter configured to convert the second residual vibration signal into a digital signal, and may be configured to determine the state of the ejection unit based on the second residual vibration signal converted into the digital signal and the temperature information signal.

According to this head unit, it becomes possible to directly acquire the amplitude of the residual vibration signal, the acquisition accuracy of the signal waveform of the residual vibration signal is improved, and the determination accuracy of the state of the ejection unit is improved.

In one aspect of the head unit described above,
the analog-to-digital converter may be configured to convert the temperature information signal into a digital signal, and
the determination circuit may be configured to determine the state of the ejection unit based on the second residual vibration signal converted into the digital signal and the temperature information signal converted into the digital signal.

According to this head unit, by converting the second residual vibration signal and the temperature information into the digital signals with the single analog-to-digital converter, it is possible to realize the reduction in size of the head unit.

An aspect of a liquid ejection apparatus includes:
a head unit configured to eject a liquid onto a medium; and
a control unit configured to control an operation of the head unit, wherein
the head unit includes
an ejection unit that includes a piezoelectric element driven by a drive signal and that is configured to eject a liquid in accordance with drive of the piezoelectric element,
a waveform shaping circuit to which a first residual vibration signal corresponding to a residual vibration caused by the drive signal is input, and which is configured to output a second residual vibration signal obtained by shaping a waveform of the first residual vibration signal,
a temperature detection circuit configured to output a temperature information signal corresponding to a temperature of the waveform shaping circuit, and
a determination circuit configured to determine a state of the ejection unit,
the waveform shaping circuit includes an amplifier circuit configured to amplify the first residual vibration signal and a gain setting circuit configured to set a gain of the amplifier circuit, and is configured to output the second residual vibration signal based on a signal amplified by the amplifier circuit,
the amplifier circuit and the gain setting circuit are configured as a single semiconductor device, and
the determination circuit is configured to determine the state of the ejection unit based on the second residual vibration signal and the temperature information signal.

According to this liquid ejection apparatus, since the amplifier circuit and the gain setting circuit are configured as the single semiconductor device, an influence of noise can be reduced due to the detection of the first residual vibration on the one hand, a possibility that the gain of the amplifier circuit changes due to an influence of the temperature increases, and as a result, there arises a possibility that the detection accuracy of the amplitude of the second residual, vibration signal decreases on the other hand. In contrast, according to this liquid ejection apparatus, by the determination circuit determining the state of the ejection unit based on the second residual vibration signal and the temperature information signal corresponding to the temperature of the waveform shaping circuit, it is possible to appropriately correct a change in gain of the amplifier circuit due to the influence of the temperature. As a result, the determination accuracy of the state of the ejection unit in the determination circuit is improved.

In one aspect of the liquid ejection apparatus described above,
at least a part of the temperature detection circuit may be provided to the semiconductor device.

According to this liquid ejection apparatus, since the temperature detection circuit is formed of the same semiconductor device as that of the amplifier circuit and the gain setting circuit, the reduction in size of the head unit and the liquid ejection apparatus can be realized.

In one aspect of the liquid ejection apparatus described above,
the head unit may include
a print head including the ejection unit,
a flexible wiring board having one end electrically coupled to the print head, and
a wiring board to which another end of the flexible wiring board is electrically coupled,
the semiconductor device may be provided to the flexible wiring board, and
at least a part of the temperature detection circuit may be provided to the wiring board.

In one aspect of the liquid ejection apparatus described above,
the determination circuit may include an analog-to-digital converter configured to convert the second residual vibration signal into a digital signal, and may be configured to determine the state of the ejection unit based on the second residual vibration signal converted into the digital signal and the temperature information signal.

According to this liquid ejection apparatus, it becomes possible to directly acquire the amplitude of the residual vibration signal, the acquisition accuracy of the signal waveform of the residual vibration signal is improved, and the determination accuracy of the state of the ejection unit is improved.

In one aspect of the liquid ejection apparatus described above,
the analog-to-digital converter may be configured to convert the temperature information signal into a digital signal, and
the determination circuit may be configured to determine the state of the ejection unit based on the second residual vibration signal converted into the digital signal and the temperature information signal converted into the digital signal.

According to this liquid ejection apparatus, by converting the second residual vibration signal and the temperature information into the digital signals with the single analog-to-digital converter, it is possible to realize the reduction in size of the head unit.

What is claimed is:

1. A head unit comprising:
an ejection unit that includes a piezoelectric element driven by a drive signal and that is configured to eject a liquid in accordance with drive of the piezoelectric element;
a waveform shaping circuit to which a first residual vibration signal corresponding to a residual vibration caused by the drive signal is input, and which is configured to output a second residual vibration signal obtained by shaping a waveform of the first residual vibration signal;
a temperature detection circuit configured to output a temperature information signal corresponding to a temperature of the waveform shaping circuit; and
a determination circuit configured to determine a state of the ejection unit, wherein
the waveform shaping circuit includes an amplifier circuit configured to amplify the first residual vibration signal and a gain setting circuit configured to set a gain of the amplifier circuit, and is configured to output the second residual vibration signal based on a signal amplified by the amplifier circuit,
the amplifier circuit and the gain setting circuit are configured as a single semiconductor device, and
the determination circuit is configured to determine the state of the ejection unit based on the second residual vibration signal and the temperature information signal.

2. The head unit according to claim 1, wherein
at least a part of the temperature detection circuit may be provided to the semiconductor device.

3. The head unit according to claim 1, further comprising:
a print head including the ejection unit;
a flexible wiring board having one end electrically coupled to the print head; and
a wiring board to which another end of the flexible wiring board is electrically coupled, wherein
the semiconductor device is provided to the flexible wiring board, and
at least a part of the temperature detection circuit is provided to the wiring board.

4. The head unit according to claim 1, wherein
the determination circuit includes an analog-to-digital converter configured to convert the second residual vibration signal into a digital signal, and is configured to determine the state of the ejection unit based on the second residual vibration signal converted into the digital signal and the temperature information signal.

5. The head unit according to claim 4, wherein
the analog-to-digital converter is configured to convert the temperature information signal into a digital signal, and
the determination circuit is configured to determine the state of the ejection unit based on the second residual vibration signal converted into the digital signal and the temperature information signal converted into the digital signal.

6. A liquid ejection apparatus comprising:
a head unit configured to eject a liquid onto a medium; and
a control unit configured to control an operation of the head unit, wherein
the head unit includes
an ejection unit that includes a piezoelectric element driven by a drive signal and that is configured to eject a liquid in accordance with drive of the piezoelectric element,
a waveform shaping circuit to which a first residual vibration signal corresponding to a residual vibration caused by the drive signal is input, and which is configured to output a second residual vibration signal obtained by shaping a waveform of the first residual vibration signal,
a temperature detection circuit configured to output a temperature information signal corresponding to a temperature of the waveform shaping circuit, and
a determination circuit configured to determine a state of the ejection unit,
the waveform shaping circuit includes an amplifier circuit configured to amplify the first residual vibration signal and a gain setting circuit configured to set a gain of the amplifier circuit, and is configured to output the second residual vibration signal based on a signal amplified by the amplifier circuit,
the amplifier circuit and the gain setting circuit are configured as a single semiconductor device, and
the determination circuit is configured to determine the state of the ejection unit based on the second residual vibration signal and the temperature information signal.

7. The liquid ejection apparatus according to claim 6, wherein
at least a part of the temperature detection circuit is provided to the semiconductor device.

8. The liquid ejection apparatus according to claim 6, wherein
the head unit includes
a print head including the ejection unit,
a flexible wiring board having one end electrically coupled to the print head, and
a wiring board to which another end of the flexible wiring board is electrically coupled,
the semiconductor device is provided to the flexible wiring board, and
at least a part of the temperature detection circuit is provided to the wiring board.

9. The liquid ejection apparatus according to claim 6, wherein
the determination circuit includes an analog-to-digital converter configured to convert the second residual vibration signal into a digital signal, and is configured to determine the state of the ejection unit based on the second residual vibration signal converted into the digital signal and the temperature information signal.

10. The liquid ejection apparatus according to claim 9, wherein
the analog-to-digital converter is configured to convert the temperature information signal into a digital signal, and
the determination circuit is configured to determine the state of the ejection unit based on the second residual vibration signal converted into the digital signal and the temperature information signal converted into the digital signal.
